(19) United States
(12) Patent Application Publication
(10) Pub. No.: US 2006/0062163 A1
(43) Pub. Date: Mar. 23, 2006

(54) Communication method

(75) Inventor: Yuji Matsumoto, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/031,719

(22) Filed: Jan. 7, 2005

(30) Foreign Application Priority Data
Sep. 17, 2004 (JP) 2004-272139

(51) Int. Cl. H04B 7/005; H04Q 7/00

(52) U.S. Cl. 370/278; 370/329

(57) ABSTRACT

A communication method by which a first device and a second device each having a wireless interface perform communications, includes a step of making the first device transmit a communication element ensuring request containing a predetermined communication pattern, a step of making the second device judge from a relationship with a self-allocated resource quantity whether a communication having the predetermined communication pattern contained in the communication element ensuring request is acceptable or not, if judged acceptable, generate and transmit a new address, and retain an associated relationship between the new address and the predetermined communication pattern, a step of making the first device transmit predetermined information by use of the new address, and a step of making the second device transfer the predetermined information transmitted by use of the new address with the predetermined communication pattern associated with the new address.

### BACKGROUND OF THE INVENTION

The invention relates to a technology for communications performed by a first device and a second device that have wireless interfaces.

A wireless LAN based on IEEE802.11, etc. involves using a common wireless medium for exchanging control information and connection information of a real-time traffic (which hereinafter be abbreviated to RTT) between a station (STA) and an access point (AP).

In the AP defined as the wireless medium, however, a conflict occurs in the wireless medium because of the same medium similarly receiving the information with respect to a non-real-time traffic (which will hereinafter be abbreviated to NRTT) as well, and hence there arises a problem that it is difficult to ensure a quality of the RTT.

A scheme (refer to patent document 1) for solving the problem about ensuring the quality of the RTT is that the RTT and the NRTT are distributed by restricting a wireless area with time. This scheme involves employing a system that manages bands utilizable on the AP side after accepting a QoS (Quality of Service) request, checks the conflict and gives a response to the STA. The STA performs a time-based transmission according to the response information.

Further, the following scheme (refer to patent document 2) is proposed. The STA side classifies the applications according to the RTT and the NRTT, and requests a resource each time in the wireless area with respect to the RTT. The AP side, if possible of allocating the resources, allocates the bands and, if there exist a plurality of requests, allocates an optimum resource to the band in away that adjusts balance between a necessary capacity required for unit time and a capacity on the whole.

In the former scheme, however, the wireless area is restricted by the time restriction system, and, as a concomitant of this, if no information exists for the time when ensured as the QoS request demands, there occurs a condition that these bands can not be efficiently utilized. Moreover, generally a plurality of terminals reside in the wireless bands, and, in the case of adopting the system that gives the time restriction to the wireless bands, there are affected by an intensity of radio waves, a data loss, etc., resulting in a difficulty of adjustment of timing. Further, the synchronization must be done, and therefore the time coincidence itself requires a complicated function.

While in the latter scheme, there is a problem of causing a necessity that a resource count be ensure each time. Moreover, a terminal side requesting the utility resource must have traffic occurrence information about the RTT that is used for making a request. Hence, the request is made after monitoring the occurrence information given from the application, and this is not said to be advantageous in terms of the time. Furthermore, there is a possibility that the requests might occur in burst from the plurality of terminals, and, if occurred, a conflict processing algorithm becomes complicated.

Still further, in both of those schemes, the access from the STA side is the same with the RTT and the NRTT, and hence there still remains a possibility that the RTT might not be ensured due to an encounter with unlawful accessing.

[Patent Document 1]
Japanese Patent Application Laid-Open Publication No. 2003-209554

[Patent Document 2]
Japanese Patent Application Laid-Open Publication No. 2003-169363

### SUMMARY OF THE INVENTION

It is an object of the invention to provide a technology for ensuring a quality of a specified communication such as RTT, etc.

The invention was devised to solve the problems and takes the following constructions.

A first aspect of the present invention is a communication method by which a first device and a second device each having a wireless interface perform communications. In the first aspect of the invention, the first device transmits a communication element ensuring request containing a predetermined communication pattern. The second device judges from a relationship with a self-allocated resource quantity whether a communication having the predetermined communication pattern contained in the communication element ensuring request is acceptable or not, if judged acceptable, generates and transmits a new address, and retains an associated relationship between the new address and the predetermined communication pattern. The first device transmits predetermined information by use of the new address. And the second device transfers the predetermined information transmitted by use of the new address with the predetermined communication pattern associated with the new address.

According to the invention, only when judging that the quality can be ensured, the new address is generated and transmitted to the first device. Then, only the predetermined information transmitted by using the new address is transferred. Accordingly, even in the case where the first device performs the specified communication such as the RTT, etc., its quality (QoS) can be ensured.

The communication method of the first aspect of the invention may further comprises, for example, a step of storing the predetermined information transmitted by use of the new address in a memory, and the second device reads the predetermined information from the memory and transfers the predetermined information in accordance with the predetermined communication pattern associated with the new address.

With this first aspect of the invention, even when the first device performs the specified communication such as the RTT, etc., the quality (QoS) thereof can be ensured. Further, the security can be improved.

In the communication method, for instance, a single or a plurality of different devices are assigned at least one of a data retaining function, a data collecting function based on the communication element ensuring request and a function of transmitting the information to a network among functions implemented on the second device.

This exemplifies a distributed example of the functions implemented on the second device.

In the communication method of the first aspect of the invention, for example, the second device may transmit a transmission permissible period information for accepting the first device. The first device may transmit the transmission permissible period information. And the second device may transfer the retained information in accordance with the transmission permissible period information.

In the communication method of the first aspect of the invention, for instance, the first device is a mobile communication device, and the second device is a wireless base station.

This exemplifies the first device and the second device. Therefore, the first device and the second device are not limited to these types of devices. For example, the first device may be a mobile communication device, and the second device may be a mobile support device (Home Agent).

In the communication method of the first aspect of the invention, for example, the wireless interface possessed by the first device is a normal interface.

This exemplifies the wireless interface possessed by the first device. Hence, the wireless interface possessed by the first device is not limited to this type of interface.

Further, the invention can be specified as the invention of the device as follows.

A second aspect of the present invention is a communication device comprises a creating unit creating a communication element ensuring request, an associating unit associating with an application for making the communication element ensuring request, for a transmitting unit transmitting the communication element ensuring request, and for a performing unit performing the communication by use of the new address with respect to the application that has done the associating, when receiving a new address from a device which received the communication element ensuring request.

The communication device of the second aspect of the invention may further comprises, for instance, a performing unit performing the communication without using the new address with respect to the application making none of the communication element ensuring request.

Moreover, the invention can be specified as the invention of the device as follows.

A third aspect of the present invention is a communication device makes a communication element ensuring request for a plurality of second devices in a network in which there exist the plurality of devices each implementing a function possessed by the second device.

In the communication device of the third aspect of the invention, for example, the communication element ensuring request is further made for the second device belonging to the neighborhood of a communication destination terminal.

Further, in the communication device of the third aspect of the invention, for instance, the transmitting unit may further transmit a new communication element ensuring request, thereby changing allocation of resources with respect to a new piece of address information.

Moreover, in the communication device of the third aspect of the invention, for example, the transmitting unit may further transmit a new communication element ensuring request, thereby requesting, as additional information, an address created afresh by dividing allocation information in the address information.

The invention can be specified as the invention of the device as below.

A fourth aspect of the invention is a communication control device comprises a receiving unit receiving a communication element ensuring request containing a predetermined communication pattern from a first device, a creating unit creating a new address associated with the predetermined communication pattern, and a transmitting unit transmitting the new address information to the first device.

In the communication control device of the fourth aspect of the invention, for instance, the creating unit may generate a random address.

Moreover, in the communication control device of the fourth aspect of the invention, e.g., a restriction of a predetermined period of time is set in the new address.

Moreover, the communication control device of the fourth aspect of the invention may further comprises, for instance, a retaining unit retaining, for a fixed period of time, predetermined information transmitted by using the new address from the first device, and a collecting unit collecting and transferring the predetermined information on the basis of a predetermined communication pattern from the retaining unit.

Still further, in the communication control device of the fourth aspect of the invention, for example, when the first device transmits the new address, period indicating information used by the second device to effect the collection is given to the first device.

The invention can be specified as the invention of a system as follows.

A fifth aspect of the invention is a communication system in which a first device and a second device each having a wireless interface perform communications, comprises a first device transmitting a communication element ensuring request containing a predetermined communication pattern, a second device judging from a relationship with a self-allocated resource quantity whether a communication having the predetermined communication pattern contained in the communication element ensuring request is acceptable or not, if judged acceptable, generating a new address, and retaining an associated relationship between the new address and the predetermined communication pattern, and a transmitting unit transmitting the new address from the second device to the first device, wherein the first device transmits the predetermined information by use of the new address, and the second device transfers the predetermined information transmitted by use of the new address, with the predetermined communication pattern associated with the new address.

Moreover, the invention can be also specified as the invention as a communication control device.

A sixth aspect of the invention is a communication control device for performing communications with a device for transmitting predetermined information, comprises a receiving unit receiving the predetermined information transmitted from the device, a judging unit judging from a relationship with a self-allocated resource quantity whether a communication having the predetermined communication pattern is acceptable or not, when receiving the predetermined information containing a predetermined communication pattern, a generating unit generating a new address, if judged acceptable, a retaining unit retaining an associated relationship between the new address and the predetermined communication pattern, a providing unit providing the new address to the device, and a transferring unit transferring the predetermined information with the predetermined communication pattern associated with the new address, when receiving the predetermined information transmitted by use of the new address.

Yet further, the invention can be also specified as the invention of the communication device as below.

A seventh aspect of the invention is a communication device comprises a first transmitting unit transmitting a communication element ensuring request containing a predetermined communication pattern by use of a first address, a receiving unit receiving a second address transmitted from a device judging from a relationship with a self-allocated resource quantity that a communication having the predetermined communication pattern contained in the communication element ensuring request is acceptable, and a second transmitting unit transmitting the predetermined information by use of the second address.

The principle of the invention will be explained with reference to the drawings.

FIG. 1 shows a view of the principle of the invention. As shown in FIG. 1, a network system in which the communication method, etc. of the invention is actualized includes a first device m1, a second device m2 connected to a network n2, and a wireless communication network n1 extending between the first device and the second device. The network n2 is defined as a general type of network such as the Internet, a closed network and so on.

The first device m1 has a function of performing communications with the second device m2 via the wireless communication network n1. The first device m1 makes a communication element ensuring request (containing the predetermined communication pattern according to the invention) for the second device m2 (S10). For example, when a real-time communication application is started up on the first device m1, the first device m1 makes the communication element ensuring request for the second device m2.

The second device m2, after receiving the communication element ensuring request from the first device m1, judges based on resource information of a resource allocated to the second device m2 on the basis of this request within the network whether the requested resource can be provided or not, and, if providable, generates an address for the communication element ensuring request (S11). An associated relationship between the generated address and the communication element ensuring request (containing the predetermined communication pattern according to the invention) received a short while ago, is retained in a request-pattern-to-assigned-address associating (mapping) list.

The second device m2 transmits the generated address to the first device m1 (S12).

The first device m1 switches over the real-time communication application to the address given from the second device m2 (S13).

The real-time communication application on the first device m1 sends the predetermined information to the second device m2 by use of the switched-over new address (S14). The second device m2 receives and retains a content transmitted from the first device m1 (S15). The second device m2 collects the retained information on the basis of the communication element ensuring request (the predetermined communication pattern according to the invention) associated with the address generated in S11 (S16), and transmits the thus-collected information to the network (S17). Namely, the second device m2 transfers the predetermined information transmitted by use of the new address from the first device m1 with the predetermined communication pattern associated with the new address.

As explained above, the system illustrated in FIG. 1 includes the first device m1 that transmits the communication element ensuring request containing the predetermined communication pattern (S10), and the second device m2 judging from the relation with the self-allocated resource quantity whether the communication having the predetermined communication pattern contained in the communication element ensuring request is acceptable or not, the generating, if judged acceptable, the new address (S11), and retaining the associated relationship between the new address and the predetermined communication pattern. The new address is sent to the first device m1 from the second device m2 (S12).

The first device m1 transmits the predetermined information by use of the new address given from the second device m2 (S14). The second device retains the predetermined information sent by use of the new address (S15), and transfers the thus-retained predetermined information with the predetermined communication pattern associated with the new address (S16, S17).

It is therefore possible to ensure the communication quality requested by the first device m1 (the real-time communication application). Further, the first device m1 can be utilized by use of the address based on the communication element ensuring request (the predetermined communication pattern according to the invention).

FIG. 2 shows a second mode of the principle view of the invention. As shown in FIG. 2, a different point from FIG. 1 is that a third device m3 is assigned part of the functions possessed by the second device m2.

The first device m1 makes the communication element ensuring request (containing the predetermined communication pattern according to the invention) for the third device m3 (S20). For example, when the real-time communication application is started up on the first device m1, the first device m1 makes the communication element ensuring request for the third device m3. The third device m3 retains the communication element ensuring request given from the first device m1 (showing an example of being retained in Hold a in FIG. 2).

The second device m2 periodically reads the information (the communication element ensuring request given from the first device m1) retained by the third device m3, then judges based on the resource information of the resource allocated to the second device m2 on the basis of the request within the network whether the requested resource can be provided or not, and, if providable, generates an address for the communication element ensuring request (S21). The associated relationship between the generated address and the communication element ensuring request (containing the predetermined communication pattern according to the invention) received a short while ago, is retained in the request-pattern-to-assigned-address associating (mapping) list.

The second device m2 transmits the generated address to the third device m3 (S22).

The third device m3 creates the management information (such as permitting acceptance of a packet, and configuring a retaining target and a function of Hold b) with respect to the address given from the second device m2 (S23). Thereafter, the third device m3 transmits to the first device m1 the address given from the second device m2 (S24).

The first device m1 switches over the real-time communication application to the address given from the third device m3 (S25).

The real-time communication application on the first device m1 sends the predetermined information to the third device m3 by use of the switched-over new address (S26). The third device m3 receives the content transmitted from the first device m1 and retains this content in Hold b (S27) The second device m2 collects the retained information from Hold b on the basis of the communication element ensuring request (the predetermined communication pattern according to the invention) associated with the address generated in S21 (S28), and transmits the collected information to the network (S19). Namely, the second device m2 transfers the predetermined information sent by using the new address from the first device m1 with the predetermined communication pattern associated with the new address.

Thus, the third device m3 (Hold b) is retained with the predetermined information transmitted by use of the new address from the first device m1, and the second device m2 collects the information. With this configuration, it is feasible to restrain the traffic from the terminal m1, etc. from directly affecting the second device m2 in the core-sided network.

Next, a modified example of the second mode of the principle view of the invention will be explained.

In FIG. 2, the third device m3 is provided at an anterior sage, while the second device m2 is provided at a posterior stage, however, the third device m3 and the second device m2 may be in such a relationship that these devices serve as terminal points of the network. For example, it can be presumed that the third device m3 is provided in the vicinity of the first device m1, and the second device m2 is provided in the vicinity of a new device performing communications with the first device m1. In this case, it is easy to ensure an interval (gap) size suited to not executing the communication process in the vicinity of the first device m1 but performing the communications with the new terminal.

Moreover, if the third device m3 and the second device m2 are constructed together, namely, if the second device m2 is constructed with a multi-stage configuration, the anterior-stage m2 side provides a selection filtering function in terms of the network resources, while the posterior-stage m2 side can be made to assure the quality in terms of the interval (gap).

Further, as for the address generated in S11 in FIG. 1 and in S21 in FIG. 2, for instance, as shown in FIG. 3, the second device m2 is provided with a random address generating module and generates an address (2-a) by use of a random number generated by this random address generating module, and this address may also be associated with the management address. With this scheme, a fluctuation address can be swept out, thereby making it possible to build up a solid architecture in terms of security.

Moreover, as shown in FIG. 4, in addition to the configuration shown in FIG. 2 or 3, the third device m3 (Hold c) may retain (S31) the predetermined information transmitted (S30) from a non-real-time application (or an application that does not use the communication element ensuring request) on the first device m1 (by use of an address other than the new address), and the second device m2 may collect, when there is a space area in the resources, the information (S32) and may transmit the collected information to the network (S33).

Note that the processes in S30 through S33 can be, it is considered, operated in parallel with the processes in S20 through S29 shown in FIG. 2 or 3.

FIG. 5 shows a third mode of the principle view of the invention. As shown in FIG. 5, an example of the construction is that there are one or more devices having the function of the third device m3, and the address provided by the second device m2 is processed in division by a fourth device m4.

The first device m1 makes the communication element ensuring request (containing the predetermined communication pattern according to the invention) for the third device m3 (S40). For instance, when the real-time communication application is started up on the first device m1, the first device m1 makes the communication element ensuring request for the third device m3. The third device m3 retains the communication element ensuring request given from the first device m1 (showing an example of being retained in Hold a in FIG. 5).

The second device m2 periodically reads the information (the communication element ensuring request given from the first device m1) retained by the third device m3, then judges based on the resource information of the resource allocated to the second device m2 on the basis of the request within the network whether the requested resource can be provided or not, and, if providable, generates an address for the communication element ensuring request (S41). The associated relationship between the generated address and the communication element ensuring request (containing the predetermined communication pattern according to the invention) received a short while ago, is retained in the request-pattern-to-assigned-address associating (mapping) list.

The second device m2 transmits the address generated in S41 to the fourth device m4 (S42).

The fourth device m4 creates the management information (such as permitting acceptance of a packet, and configuring a retaining target and a function of Hold d) with respect to the address given from the second device m2 (S43). At this time, the address is sent with a request for no notification of the address.

The second device m2 notifies (indication) the third device m3 of no generation of the address (S44). The third device m3 transmits the address given from the second device m2 to the first device m1 (S45).

The first device m1 switches the real-time application to the address given from the third device m3 (S46).

The real-time communication application on the first device m1 sends the predetermined information to the fourth device m4 by use of the switched-over new address (S47). The fourth device m4 receives the content transmitted from the first device m1 and retains this content in Hold d (S48).

The second device m2 collects the retained information from Hold don the basis of the communication element ensuring request (the predetermined communication pattern according to the invention) associated with the address generated in S41 (S49), and transmits the collected information to the network (S50).

It is to be noted that the third device m3 (Hold c) may retain (S52) the predetermined information transmitted (S51) from a non-real-time application (or an application that does not use the communication element ensuring request) on the first device m1 (by use of an address other than the new address), and the second device m2 may collect, when there is a space area in the resources, the information (S53) and may transmit the collected information to the network (S54).

Note that the processes in S51 through S54 can be, it is considered, operated in parallel with the processes in S40 through S49.

As discussed above, in the system shown in FIG. 5, the process with the communication element ensuring request can be separated by utilizing the network side where there is explicitly the space area, and hence, even when an unlawful load is applied on the third device m3, the fourth device m4 operates independently, thereby enabling the wireless communications of which the quality is ensured.

An example of the construction of the first device m1 will be explained with reference to FIG. 6. FIG. 6 is a functional block diagram of the first device m1.

As shown in FIG. 6, the first device m1 includes, for performing the communications, a receiving function c1, a transmitting function c2, a receipt information identifying function c3, an address generating function c4, an application management table c5, a timer function c6, a real-time application c7, a non-real-time application c8 and so on.

The first device m1 identifies via the receipt information identifying function c3 as to whether the signal is a signal for control or not. Then, the first device m1, in the case of the signal for the control, generates an address (CoA: Care-of-Address) in the address generating function c4 when receiving a router advertisement (RA). As for this address generation, there may be available a function of receiving the address based on DHCP (Dynamic Host Configuration Protocol), etc., however, herein the router advertisement is given on the assumption of the mobile IP.

Further, concerning the application management table c5 (see FIG. 8), the transfer is conducted when receiving the information, etc. as a result of effecting the transmission as the communication ensuring request demands. The application management table c5 serves to monitor the timer if there is timer information when making the communication element ensuring request. Further, when receiving the address (RCoA: Rental Care-of-Address) due to the communication element ensuring request, the address generating function c4 generates the address, and this address is retained in a RCoA field in the application management table c5.

Further, in the case of the normal communication application data, a routing function is applied (executed) to the real-time application c7 and the non-real-time application c8 that are related to the address information.

As to the transmission process from the real-time application c7 and the non-real-time application c8, the communications are performed by using the address associated in the application management table c5.

Moreover, when a period transmission request process is given from the second device m2 via the receipt information identifying function c3, the period transmission request is retained, and the information thereof is sent when transmitting the data from the terminal.

An example of the construction of the second device m2 will be explained with reference to FIG. 7. FIG. 7 is a functional block diagram of the second device m2.

As shown in FIG. 7, the second device m2 includes, for performing the communications, a receiving function b1, a transmitting function b2, buffer management information b3, a resource management function b4, a timer function b5, an address management function b6, a request-pattern-to-assigned-address associating (mapping) list b7, a filtering management function b8, etc.

The second device m2 retains the information from the receiving function b1 on the basis of the buffer management information b3. Herein, the buffer is constructed of a common control buffer for retaining the communication element ensuring request, a common data buffer for retaining the information that does not use the communication element ensuring request, and an individual buffer for dynamic management on an individual-address-basis.

The resource management function b4 periodically monitors the buffer and collects the storage information thereof.

The timer function b5 takes various types of timing depending on a variety of time periods and the content of the communication element ensuring request given from the first device m1.

The address management function b6 generates the address upon receiving the request from the resource management function b4, and transmits the generated address to the source management module b4.

The request-pattern-to-assigned-address associating (mapping) list b7 is a list used for the resource management function b4 to manage the request pattern requested by the first device m1 and the assigned address with respect to this request pattern.

The resource management function b4 is capable of providing a restriction to a providing period. Effective time is managed by utilizing the timer function b5. Further, the address is registered in the filtering management function for its being stored on the individual buffer by permitting the acceptance about the address. Thereafter, with respect to the buffer management information, an individual buffer generation request is made, and the address is transmitted by using the transmitting function b2.

According to the invention, it is possible to ensure the quality of the specified communication such as RTT, etc. Further, the flexible protocol can be utilized for the core configuration of the network. Still further, the security can be improved and the policies requested can be clearly classified by providing the point capable of controlling by use of only the address desired on the network side. Yet further, the information retained on the routing process side is utilized by way of the open gate, thereby enabling the transmission side to conduct the conscious time management. Moreover, it is feasible to restrain the invalid request from being transmitted in futility across the wireless area. Furthermore, the network linking method and the load-sharing management are facilitated. Still furthermore, when the communication involves using the present system, the information that should be assured just anterior to the communication partner terminal can be provided, and hence the present system becomes superior to other systems in terms of a gap size.

### DESCRIPTION OF THE DRAWINGS

FIG. 1 is a view of the principle of the invention (a first mode);

FIG. 2 is a view of the principle of the invention (a second mode);

FIG. 3 is an explanatory view of a modified example of the invention;

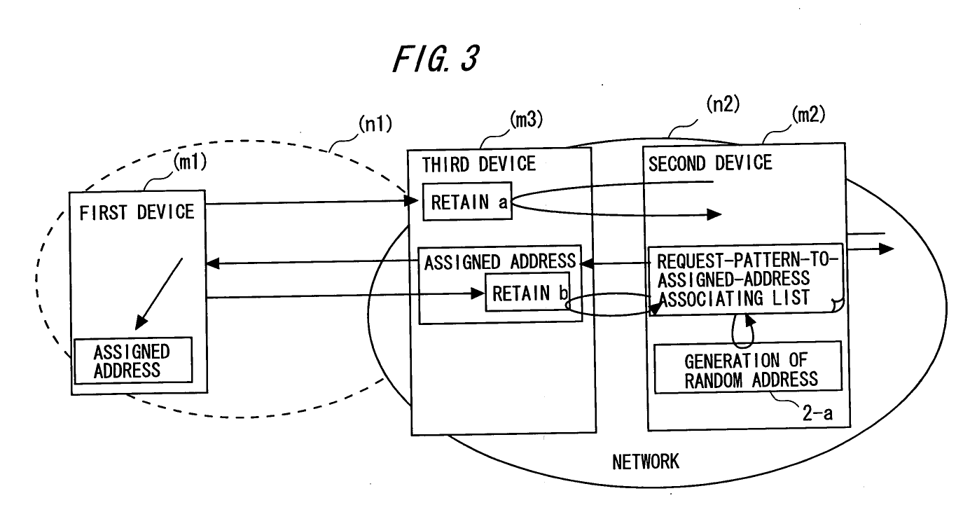

FIG. 4 is an explanatory view of a modified example of the invention;

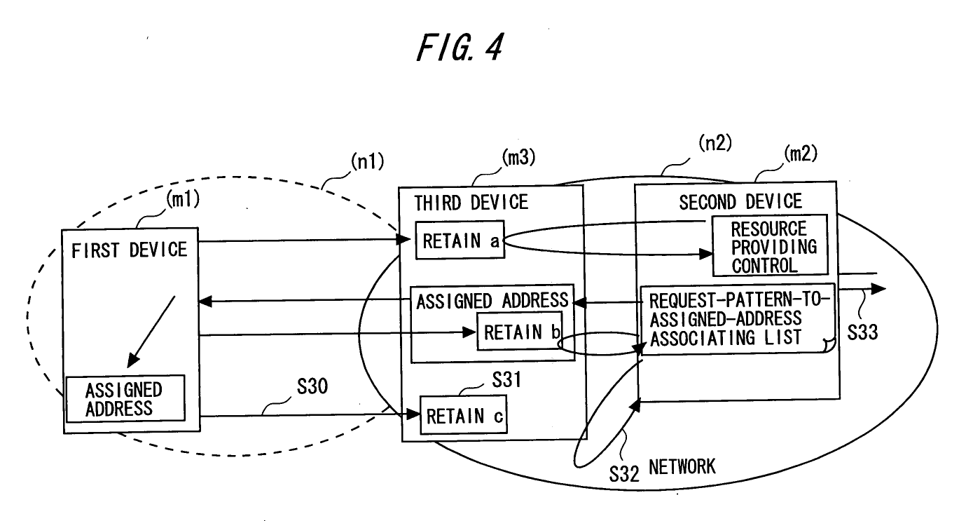

FIG. 5 is a view of the principle of the invention (a third mode);

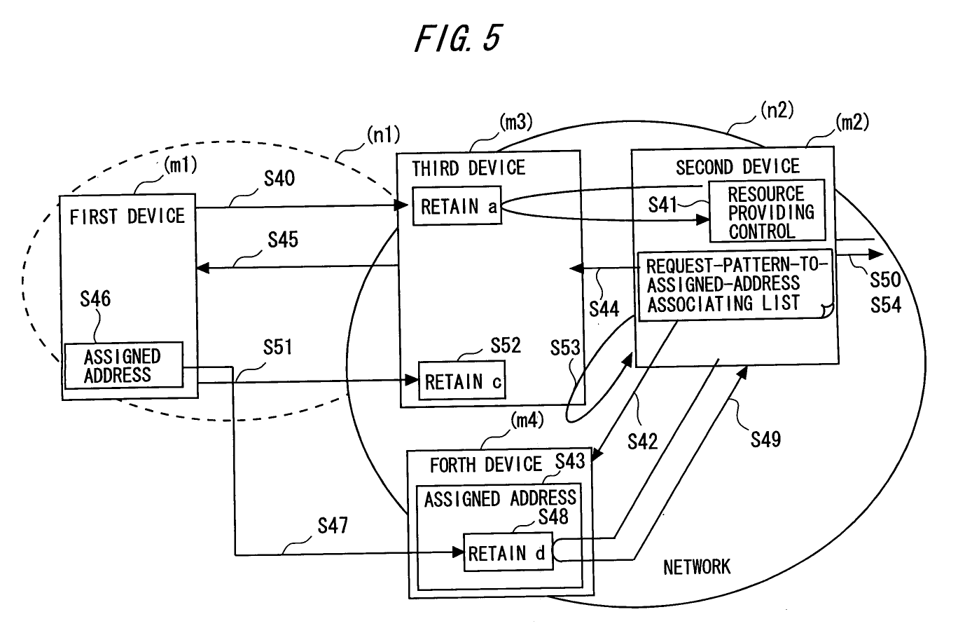

FIG. 6 is a functional block diagram of a first device m1;

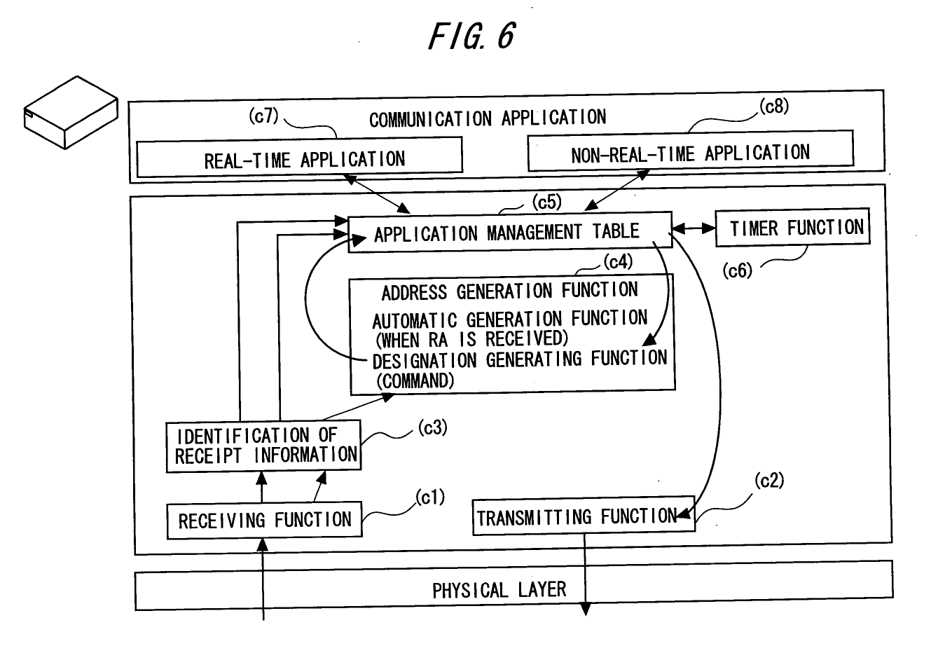

FIG. 7 is a functional block diagram of a second device m2;

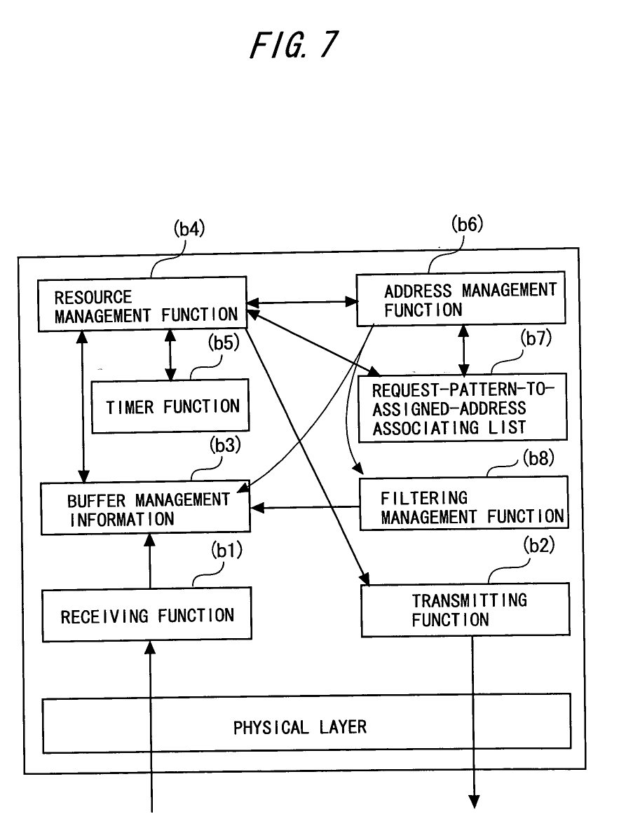

FIG. 8 is an example of an application management table;

FIG. 9 is an explanatory view of an outline or architecture of a network system as an embodiment of the invention;

FIG. 10 is an explanatory view of a communication request allocation process;

FIG. 11 is an explanatory view of a process of judging whether acceptable or not by analyzing an acceptance pattern on the basis of resources;

FIG. 12 is an explanatory view of the process of judging whether acceptable or not by analyzing the acceptance pattern on the basis of the resources;

FIG. 13 is an example of a resource management table;

FIG. 14 is a buffer management table;

FIG. 15 is an explanatory view of generating a random address;

FIG. 16 is an explanatory view of setting effective time;

FIG. 17 is an explanatory view of a resource updating process;

FIG. 18 is an explanatory view of a plural communication element ensuring process;

FIG. 19 is an explanatory view of a buffer management device replay process;

FIG. 20 is an explanatory view of a period Look-in enable process (a period Look-in gate enable request process);

FIG. 21 is an explanatory view of the period Look-in enable process (the period Look-in gate enable request process);

FIG. 22 is an explanatory flowchart of the communication element ensuring request in MN m1;

FIG. 23 is an explanatory flowchart of a process for the communication element ensuring request in RMA m2;

FIG. 24 is an explanatory flowchart of a post-acquisition process of an address in the MN m1;

FIG. 25 is an explanatory flowchart of a reading process from an individual buffer in the RMA m2;

FIG. 26 is an explanatory flowchart of a transmissible period information registering process in the RMA m2;

FIG. 27 is an explanatory flowchart of the transmissible period information registering process in the RMA m2; and

FIG. 28 is an explanatory flowchart of a reading process from a common buffer in the RMA m2.

### DETAILED DESCRIPTION OF THE INVENTION

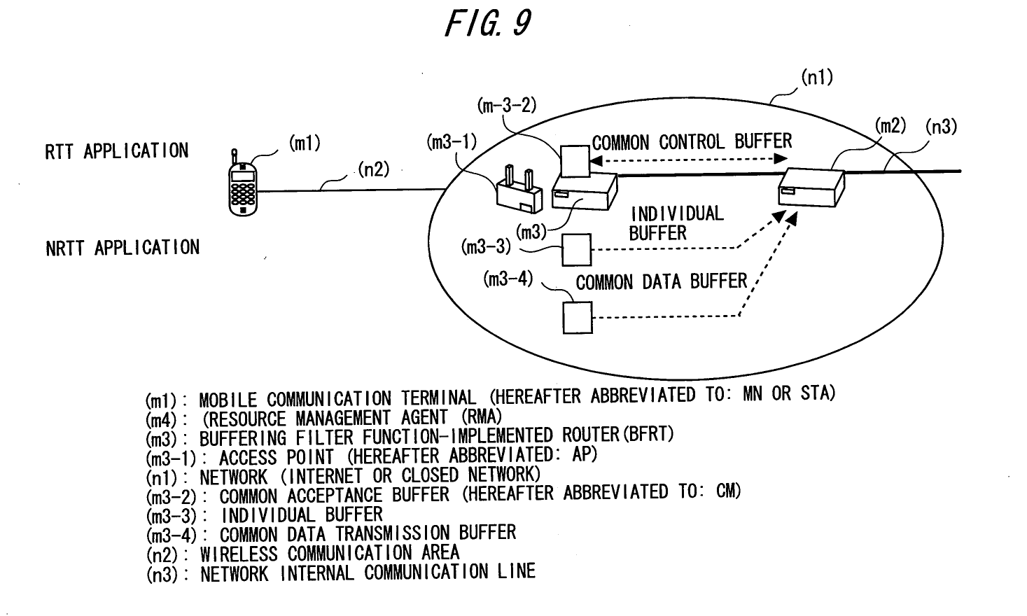

A network system will hereinafter be described by way of an embodiment of the invention with reference to the drawings. FIG. 9 is an explanatory view of an outline of architecture of the network system as the embodiment of the invention.

As shown in FIG. 9, the network system includes a mobile communication terminal m1, a resource management agent (RMA) m2, a filter function-implemented router m3 for buffering, an access point (AP) m3-1, a bugger m3-2, a buffer m3-3, a buffer m3-4, networks n1 through n3, and so on.

The mobile communication terminal (which will hereinafter be also abbreviated to MN) m1 is a Mobile Node (which will hereinafter be abbreviated to MN) or a station (which will hereinafter be abbreviated to STA), and has a function capable of separately utilizing a usage address according to RTT and NRTT.

The resource management agent (which will hereinafter be also abbreviated to RMA) m2 has a function of grasping a transmission resource quantity to the mobile communication terminal m1, and comprises a process for acquiring information for a self-managed area with respect to each router m3 and an address management function for transferring the information.

The buffering filter function-implemented router (which will hereinafter be also termed BFR) m3 is constructed of the buffers (m3-2, m3-3, m3-4) having three functions.

The access point (AP) m3-1 has a function of transferring data from the mobile communication terminal m1 to the network n3. In the following discussion, it is assumed that the BFR m3 includes this function.

The buffer m3-2 is a buffer that accepts common QoS (Quality of Service) (which will hereinafter be also referred to as a common acceptance buffer). The buffer m3-3 is a buffer that manages the individual address and conducts the management for every address (which will hereinafter be also called an individual buffer). The buffer m3-4 is a common data transmission buffer (which will hereinafter be also termed a common data transmission buffer).

The network n1 is a network to which the mobile communication terminal m1 belongs when gaining an access. The network N2 is defined as a wireless communication area. The network n3 is defined as a backbone for the network.

(Communication Request Allocation Process)

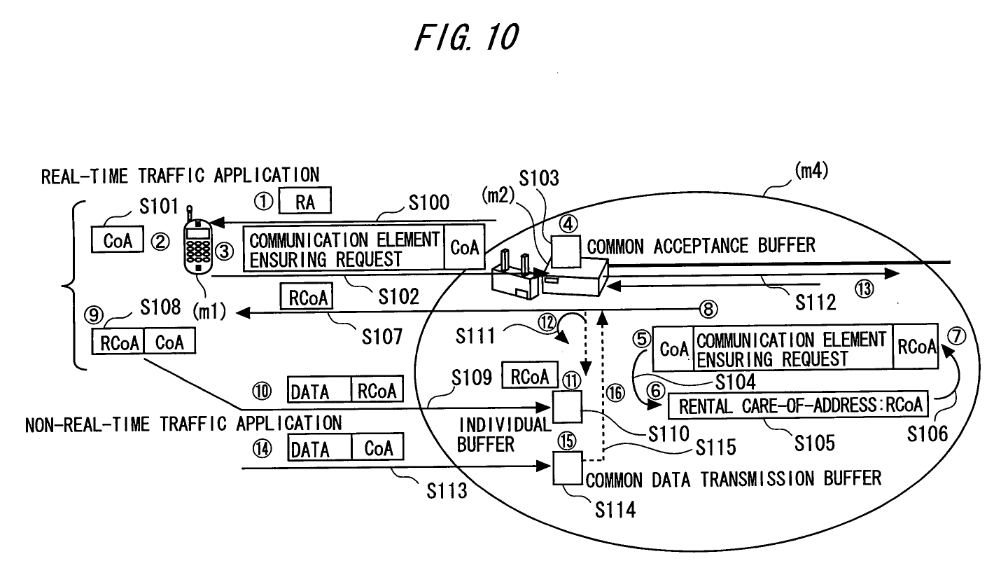

A communication request allocation process will be explained with reference to FIG. 10.

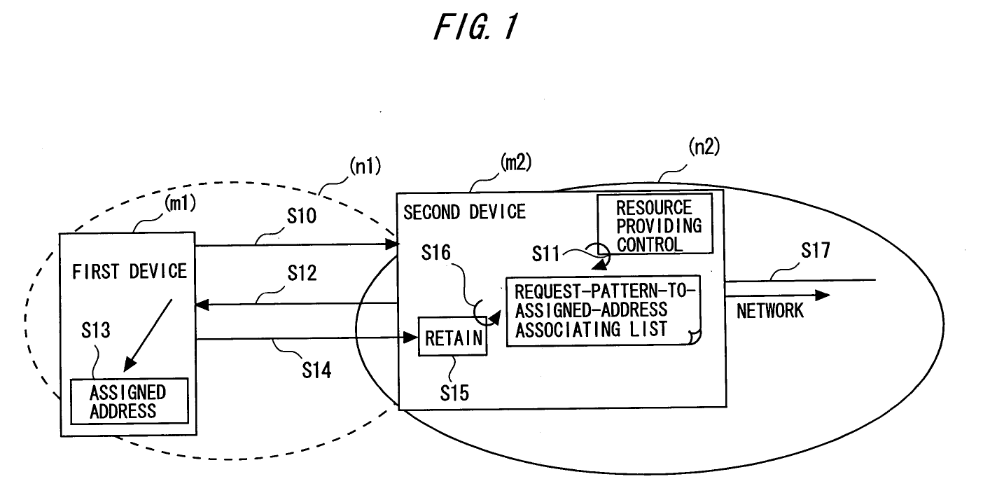

In the following discussion, it is assumed that the BFR m3 is incorporated into the RMA m2, thus attaining an integral construction (corresponding to FIG. 1).

The RMA m2 having also a function of the access router together sends a router-advertisement at predetermined timing (S100).

The MN m1 creates a care-of-address CoA by use of this (S101). The MN m1 generates a communication element ensuring request (a characteristic requirement of a real-time application). The MN m1 sends to the RMA m2 the communication element ensuring request by use of the address CoA created in S101 (S102).

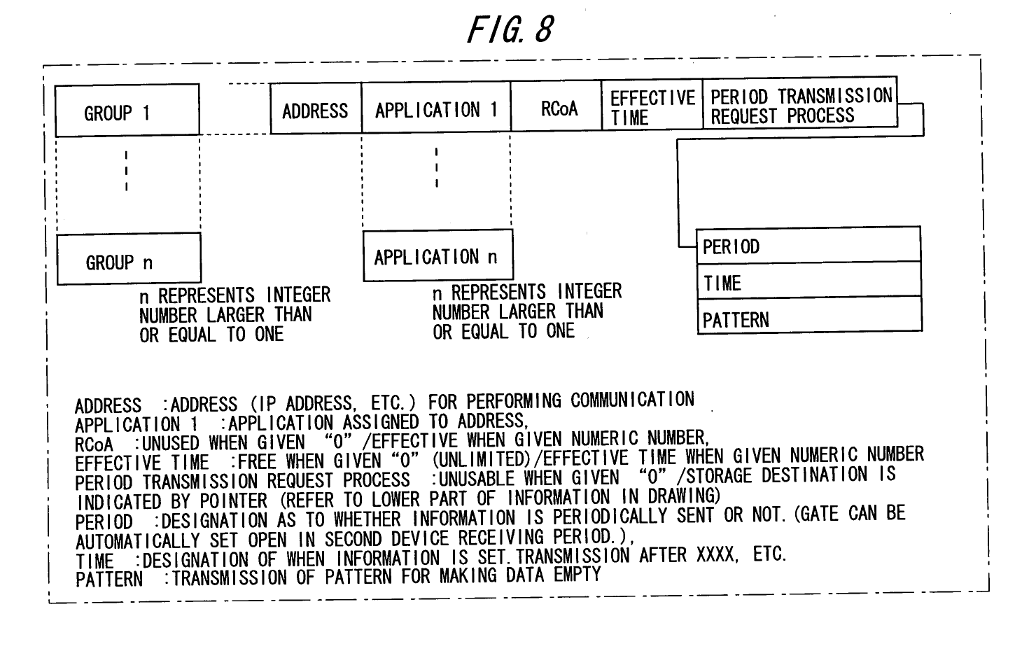

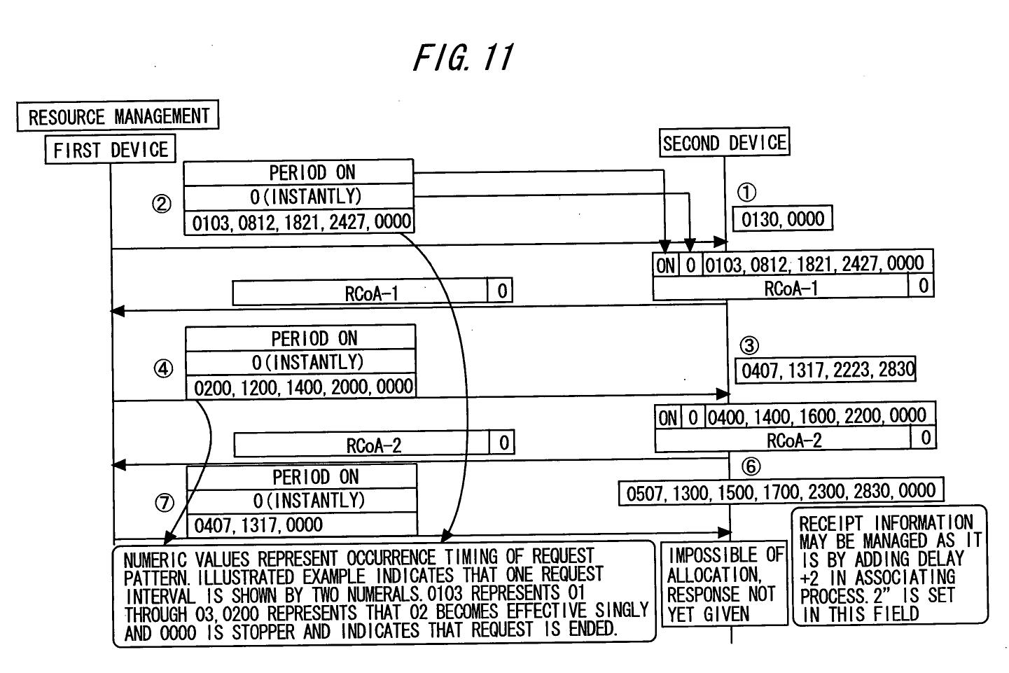

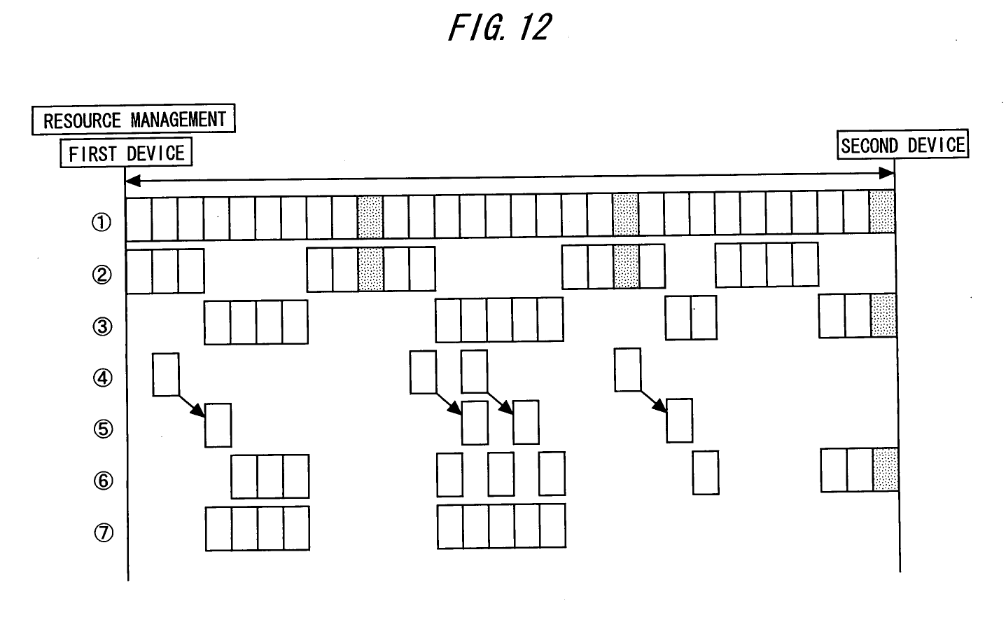

The communication element ensuring request includes at least one of a period, time and a pattern (corresponding to a predetermined communication pattern according to the invention) shown in FIG. 8. For instance, FIG. 11 shows, by way of the communication element ensuring request, an example of transmitting Period=ON, Time=0 (instantaneously) and Pattern=0103, 0812, 1821, 2427, 0000 to the RMA m2 from the MN m1. This pattern represents that thirty resources (one box in FIG. 12 indicates one resource) exist as the resources between the MN m1 and the RMA m2 as shown in FIG. 12. Among 30 resources, 0103 in the pattern represents a request for three resources from a 01th resource up to a 03th resource, 0812 represents a request for five resources from a 08th resource to a 12th resource, 1821 indicates a request for four resources from an 18th resource to a 21th resource, and 2427 indicates a request for four resources from a 24th resource to a 27th resource, respectively. Note that 0000 represents an end of the request. Incidentally, the pattern shown herein is a numerically-valued (digitized) example with respect to want-to-utilize positions. Further, the time shown herein may be either the normal time or counter information of numerical values digitized.

The RMA m2 includes the CoA address with respect to the communication element ensuring request (request condition) given from the MN m1 and also a control signal (a period, etc.), and therefore stores the communication element ensuring request on a common control buffer (S103) The RMA m2 periodically reads the communication element ensuring request from the common control buffer (S104).

The RMA m2 refers to a resource management table retained by the RMA m2 itself, and judges based on a self-allocated resource whether it is acceptable or not by analyzing an acceptance pattern. Then, the RMA m2, when judging that it is acceptable, generates an access address and sweeps it out.

An example of this operation will be explained with reference to FIGS. 11 and 12. Note that the communication element ensuring requests indicated by the numerals are used as those in common throughout FIGS. 11 and 12. In (1) (which is indicated by a circled numeral in FIGS. 11 and 12, and the same representation is likewise used hereinafter), the RMA m2 shows a band quantity allocated to the network, and in this case it follows that 30 resources are given. In (2), a resource request (a predetermined communication pattern) from the MN m1 is a process requested with this pattern, and the RMA m2, the allocation being possible, retains this request pattern and sends an address (RCoA that will be described later on) associated with this pattern to the MN m1.

(3) indicates a residual band of the resources possessed by the RMA m2. (4) shows a case in which a new resource request is sent from the MN m1, and, the RMA m2 being unable to assign the process as it is, (5) a location to which the pattern is allocated is searched for by shifting a time-base. In this case, a representation is that a backward shift is done by one. This request pattern is retained as will be explained later on, and the address (RCoA that will hereinafter be described) is sent to the MN m1. (6) indicates a residual band of the resources possessed by the RMA m2.

(7) shows a case in which a new resource request is transmitted from the MN m1, however, the RMA m2, there being no band that meets the request, rejects the acceptance by sending back no address.

Further, a resource allocation management process in FIG. 11 involves associating the process with the address.

Incidentally, though supplementary, the request from the MN m1 is given a width of request time when making the pattern request, thereby facilitating execution of allocating the resources managed by the RMA m2. Then, frequent occurrences of the resource request may be prevented by sending back the time till the resource pattern is started. The address swept out is to be created as an addition on the side of the MN m1. It follows that the MN m1 uses the swept-out address for the application data related to the real-time application. Further, as for the swept-out address, on the side of the RMA, a buffer is generated, and an operation of transmitting the data the network is performed at timing determined inside, thereby actualizing the real-time communications. Moreover, non-real-time information can be utilized by use of the previous address without any change. Each of these points will be explained later on.

It is judged as described above whether acceptable or not.

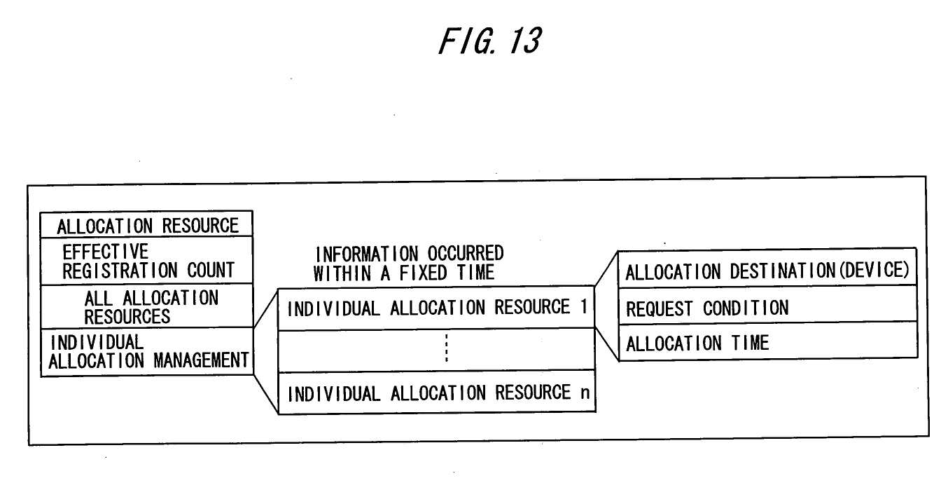

The resource management table (see FIG. 13) retains, as shown in FIG. 11, the pattern 0130, 0000. This pattern represents that 30 resources are, as shown in FIG. 11, allocated to the RMA m2.

The RMA m2, if acceptable, generates a unique rental care-of-address (RCoA) for processing the pattern on the network side (S105).

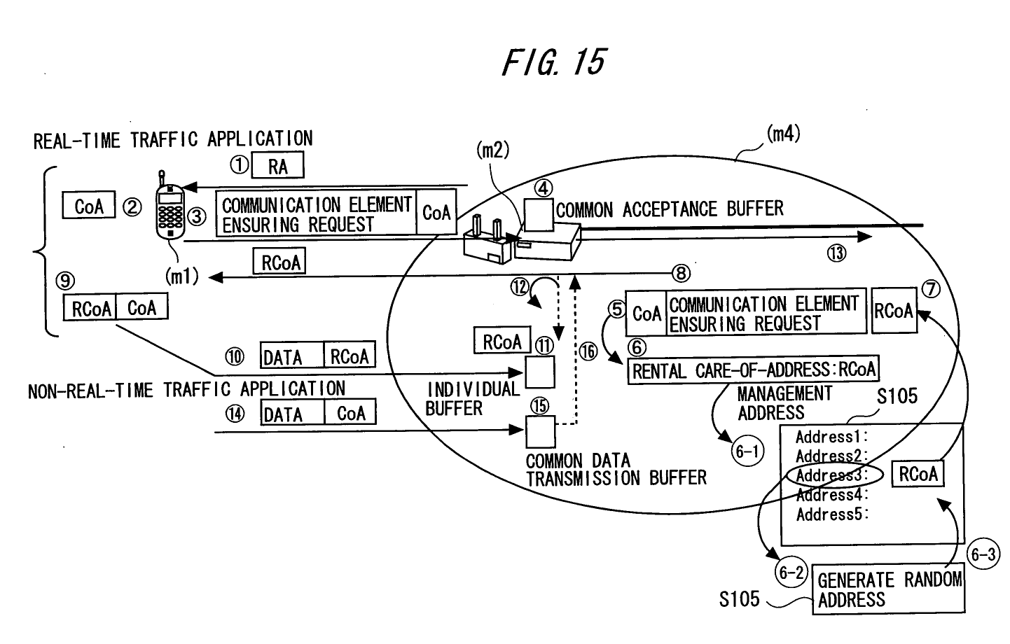

Note that with respect to the address (RCoA) generated in S105, as shown in FIG. 15, a random address is generated (S105) and may be retained in a way that associates this random address with the self-managed address (S105). With this scheme, the fixed address is not always utilized, and hence the security can be strengthened.

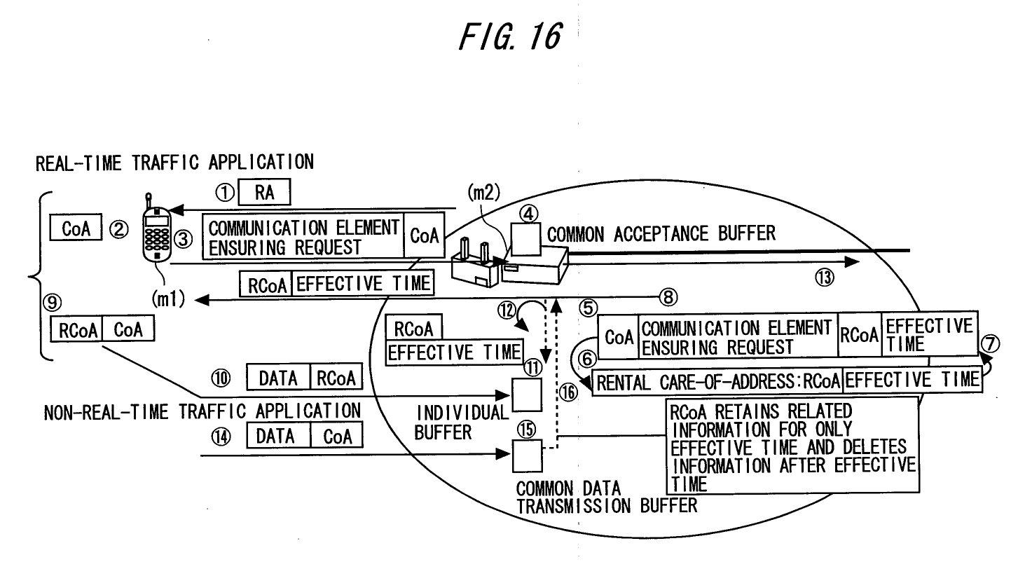

Moreover, when generating the address in S105, an effective period of time of this address may also be set (see FIG. 16).

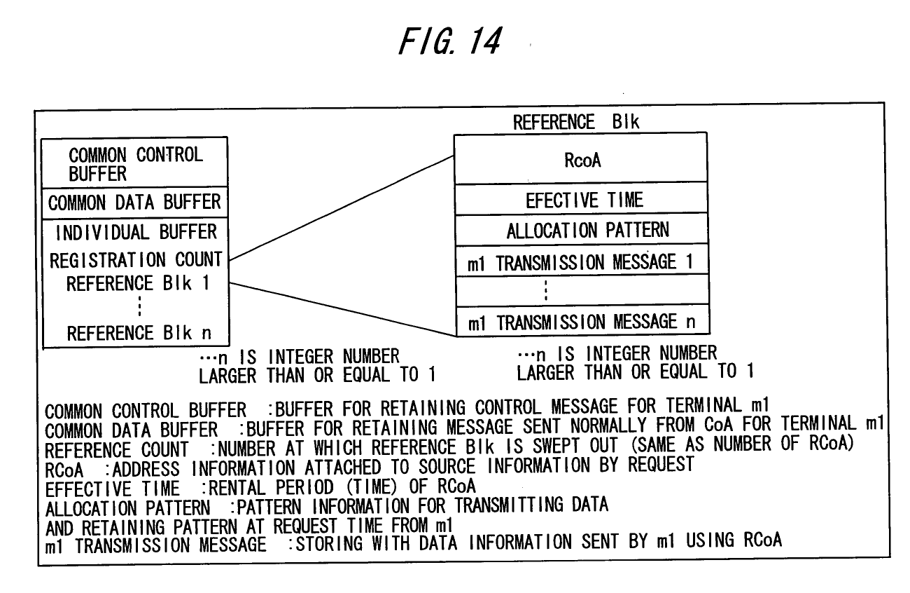

The RMA m2 registers the generated address RCoA and the communication element ensuring request (including also, if set, the effective time. See FIG. 16) received a short while ago in the buffer management table shown in FIG. 14. The buffer management table (see FIG. 14) retains, as shown in FIG. 14, for instance, [ON/0/0103, 0812, 1821, 2427, 0000/RCoA-1/0]. In FIG. 14, [RCoA-1] indicates the generated address RCoA, and [ON/0/0103, 0812, 1821, 2427, 0000] represents the received communication element ensuring request.

Further, the RMA m2, after retaining the assigned address RCoA for management RCoA information (S106), generates an individual buffer for accepting (retaining) the transmission from RCoA, and, sends RCoA (together with, if set, the effective time. See FIG. 16) to the MN m1 (S107). It is to be noted that when setting the effective time, for instance, as shown in FIG. 14, the individual buffer (refer to B1k) is stored with this effective time, and the request from the address concerned is accepted for only this effective time. If the effective time elapses, the management information is released.

The MN m1, after receiving the address RCoA from the RMA m2, (creates and) registers RCoA in its own application management table (S108). Through this process, an address relationship with the real-time application used in the communication element ensuring request is changed from CoA to RCoA.

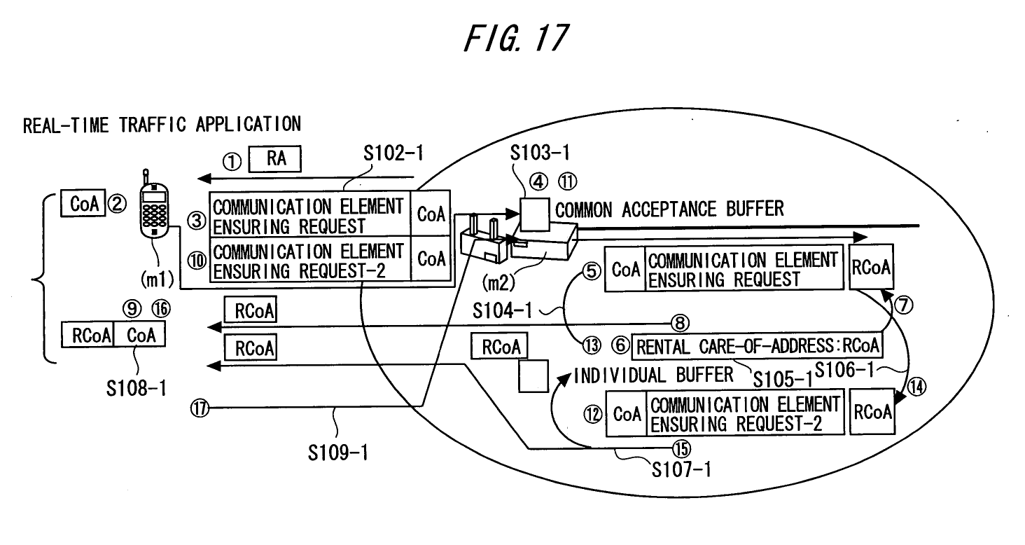

Namely, hereafter, the real-time application transmits the data (corresponding to predetermined information according to the invention) to the RMA m2 by use of RCoA (S109). Note that when receiving together with the effective time, for example, as shown in FIG. 17, an update request can be made before the elapse of this effective time.

The RMA m2 temporarily stores (buffers) the data, the address RCoA being contained therein, given from the MN m1 (the real-time application) in the individual buffer individually generated a short while ago for RCoA (S110) FIG. 13 shows a storage example of the individual buffer. The data from the MN m1 are retained as in the case of m1 transmission messages 1 through n1 (data from m1).

The RMA m2 reads the information from the individual buffer with a specified period on the basis of the condition information when generating the address RCoA. For example, as shown in FIG. 11, when the buffer management table is registered with [RCoA-1] as RCoA and [ON/0/0103, 0812, 1821, 2427, 0000] as the pattern, the m1 transmission message is read from the individual buffer (refer to Blk) of RCoA-1 with the specified period [ON/0/0103, 0812, 1821, 2427, 0000] (S111).

The RMA m2 transmits the data read with this specified period to the destination network (S112).

Next, the processing of the non-real-time application will be explained.

The non-real-time application transmits the data to the RMA m2 by using not RCoA but CoA (S113). This is a communication process that does not employ the communication element ensuring request.

The RMA m2, since the data from the MN m1 (the non-real-time application) contains the address CoA but does not contain the control signal (the communication element ensuring request such as the period, etc.), stores this piece of data on the common buffer (S114).

The RMA m2, if it proves by referring to the self-retained resource management table that there is a space area in the communication resources, reads the storage data from the common buffer and transmits the readout data to the destination network (S115).

Note that the processes in S102 through S112 and the processes in S113 through S115 can be, it is considered, executed simultaneously.

As discussed above, the system shown in FIG. 9 includes the MN m1 transmitting the communication element ensuring request containing the predetermined communication pattern (S102), and includes the RMA m2 for judging whether or not the communication having the predetermined communication pattern contained in the communication element ensuring request is acceptable in the relation with the self-allocated resource quantity, generating the new address if judged acceptable (S105), and retaining the associated relation between this new address and the predetermined communication pattern. The new address is sent to the MN m1 from the RMA m2 (S107).

The MN m1 transmits the predetermined information by utilizing the new address given from the RMA m2 (S109). The RMA M2 retains the predetermined information sent by use of the new address (S110), and transfers the thus-retained predetermined information with the predetermined communication pattern associated with the new address (S111, S112).

It is therefore possible to ensure the communication quality requested by the MN m1 (the real-time communication application. Further, the MN m1 can be utilized with the address based on the communication element ensuring request (the predetermined communication pattern according to the invention).

Moreover, the designation is explicitly given to what executes the resource control about RTT on the network side, and, therefor, the unit time is acquired by using the buffering function and further the gate function with respect to the information stored by the buffering function, whereby the processes based on NRTT and RTT are explicitly separated and the management is conducted on the network side. Accordingly, it follows that the single user can be avoided from falling into a monopolizing status, the information subjected to the transmitting process by the user can not be sent to the network through an initiative operation of the MN m1, and the control of transmitting this information to the network is done by the initiative operation of the MN m1.

Further, the RTT of the MN m1 can be supported on the network side. Namely, when sweeping out the specified address (RCoA in FIG. 10) on the network side, address prefix data possessed by the access point AP (RMA m2 in FIG. 10) that is different from the control request is transmitted (S107) whereby the RTT process can be clearly separated in the different network by the control process. Moreover, even when the plurality of mobile nodes MN m1 exist, these can be efficiently managed.

(Resource Update Request)

In the case where the MN m1 creates RCoA in S108, if making a new communication element ensuring request (or continuance) with respect to this address RCoA, the address acquisition is conducted by utilizing again the same route as in S102 through S107. This process will be described with reference to FIG. 17.

The MN m1 generates the communication element ensuring request (a characteristic requirement of the real-time application). The MN m1 transmits this communication element ensuring request (illustrated as a communication element ensuring request-2 in FIG. 17) to the RMA m2 by using the address CoA created in S101 (S102-1).

The RMA m2, since the communication element ensuring requires (request condition) from the MN m1 contains both the address CoA and the control signal (the period, etc.), stores this communication element ensuring request on the common buffer (S103-1).

The RMA m2 periodically reads the communication element enduring request from the common control buffer (S104-1). The RMA m2 refers to the self-retained resource management table, then analyzes the acceptance pattern on the basis of the self-allocated resources, and thus judges whether acceptable or not.

The RMA m2, if judged acceptable, generates a unique rental care-of-address (which is the same as RCoA) for processing the pattern on the network side (S105-1).

The RMA m2 registers the thus-generated address RCoA and the communication element ensuring request (together with, if the effective time is set, this effective time. See FIG. 16) received a short while ago in the buffer management table shown in FIG. 14.

Further, the RMA m2, after retaining the assigned address RCoA for the management CoA information (S106-1) generates the individual buffer for accepting (retaining) the transmission from RCoA, and transmits RCoA (together with, if the effective time is set, this effective time. See FIG. 16) to the MN m1 (S107-1).

The MN m1, after receiving RCoA from the RMA m2, (creates and) registers this address RCoA in its own application management table (S108-1). With this scheme, an address relationship with the real-time application utilized in the communication element ensuring request is changed (overwritten) from CoA to RCoA.

Namely, the real-time application hereafter transmits data to RMAm2 using RCoA.

(Plural Communication Element Ensuring Process)

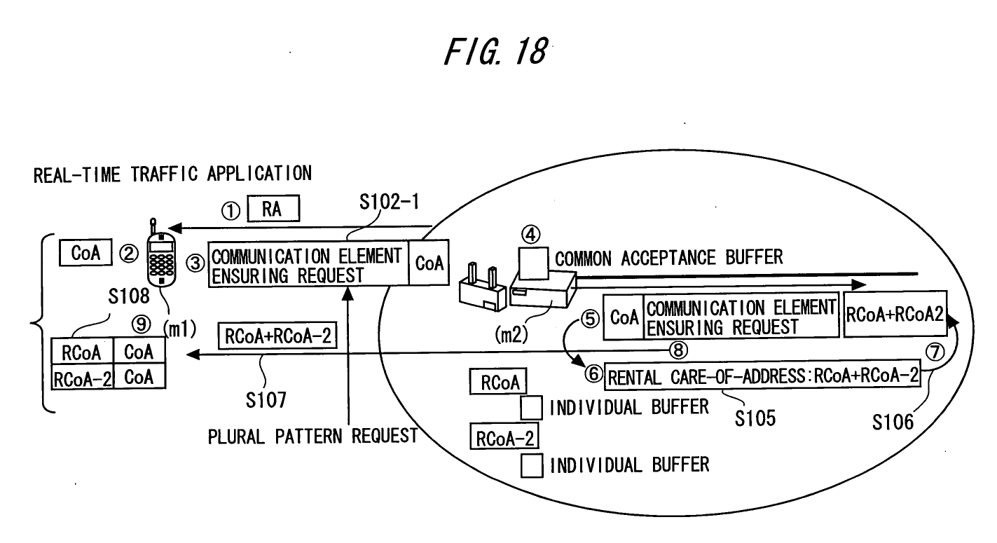

As described above, there has been discussed the example of generating one address RCoA as the rental address (S105). The scheme is not, however, limited to this and may also be done as follows. For example, as shown in FIG. 18, a plurality (two addresses are exemplified in FIG. 18) of rental addresses RCoA and RCoA-2 are generated (S105) and registered in the buffer management table. Then, after retaining the assigned RCoA for the management CoA information (S106), the individual buffer for accepting (retaining) the transmission from the RCoA may be generated, and RCoA (together with, if the effective time is set, this effective time. See FIG. 16) may be transmitted to the MN m1 (S107).

Thus, in the case of performing the real-time communications with the different terminal via the network, when the conditions enabling the communication for requesting the network for the plurality of addresses and the band are settled through negotiation with the destination terminal for communications, the address can be swept out. With this function, the network side can provide the assured communication with the communication partner (terminal).

(Buffer Management Device Relay Process)

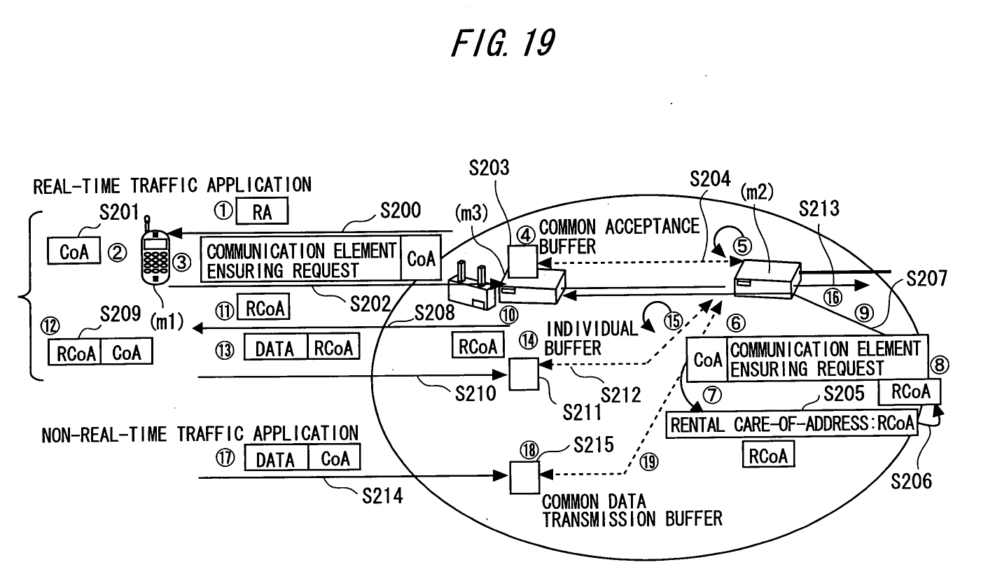

Next, a buffer management device relay process will be explained with reference to FIG. 19.

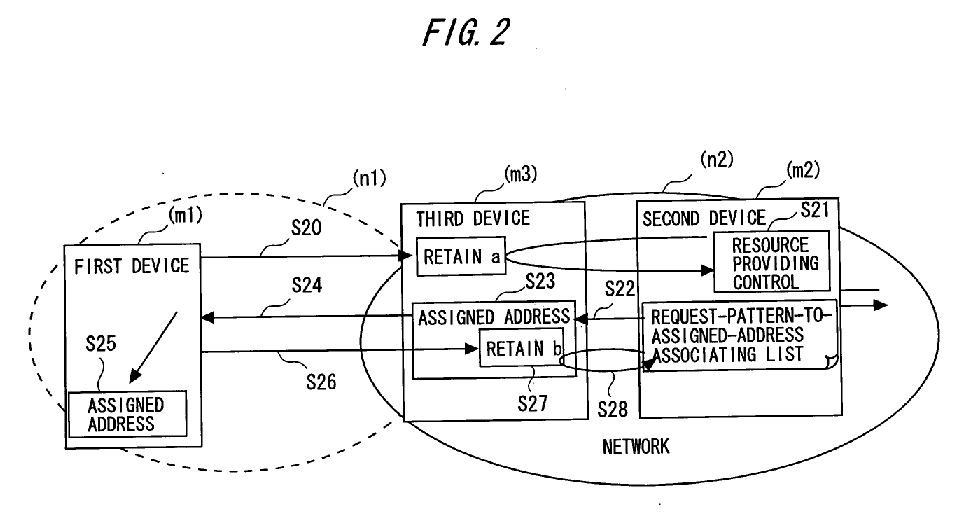

In the following discussion, it is assumed that a BFR m3 and the RMA m2 are constructed separately (corresponding to FIG. 2).

The BFR m3 sends a router advertisement at predetermined timing (S200). The MN m1 creates a care-of-address CoA by using this (S201).

The MN m1 generates the communication element ensuring request (a characteristic requirement of the real-time application). The MN m1 transmits this communication element ensuring request to the BFR m3 by using the address CoA created in S201 (S202).

The BFR m3, as the communication element ensuring request (the request condition) from the MN m1 contains both the address CoA and the control signal (the period, etc.), stores this communication element ensuring request on the common control buffer (S203).

The RMA m2 periodically reads the communication element ensuring request from the common control buffer (S204).

The RMA m2 refers to the resource management table, then analyzes the acceptance pattern on the basis of the resource assigned to the m3, and thus judges whether acceptable or not.

The RMA m2, if judged acceptable, generates a unique rental care-of-address (RCoA) for processing the pattern on the network side (S205). The RMA m2 registers the thus-generated address RCoA and the communication element ensuring request received a short while ago in the buffer management table shown in FIG. 14. Further, the RMA m2, after retaining the assigned RCoA for the management CoA information (S206), notifies the BFR M3 of the address (S207) The BFR m3 generates the individual buffer for accepting (retaining) the transmission from RCoA, and transmits RCoA to the MN m1 (S208).

The MN m1, after receiving the address RCoA from the RMA m2, registers this RCoA in its own application management table (S209). With this scheme, the address relationship with the real-time application used in the communication element ensuring request is changed from CoA to RCoA.

Namely, hereafter, the real-time application transmits the data (corresponding to the predetermined information according to the invention) to the RMA m2 by use of RCoA (S210).

The RMA m2 temporarily stores (buffers), as the data from the MN m1 (the real-time application) contains the address RCoA, this data in the individual buffer individually generated for RCoA (S211). FIG. 13 shows a storage example of the individual buffer. The data from the MN m1 are retained as in the case of m1 transmission messages 1 through n (data from m1).

The RMA m2 reads the information from the individual buffer with a specified period on the basis of the condition information when generating the address RCoA. For example, as shown in FIG. 11, when the buffer management table is registered with [RCoA-1] as RCoA and [ON/0/0103, 0812, 1821, 2427, 0000] as the pattern, the m1 transmission message is read from the individual buffer (refer to Blk) of RCoA-1 with the specified period [ON/0/0103, 0812, 1821, 2427, 0000] (S212).

The RMA m2 transmits the data read with this specified period to the destination network (S213).

Next, the processing of the non-real-time application will be explained.

The non-real-time application transmits the data to the BFR m3 by using not RCoA but CoA (S214). This is a communication process that does not employ the communication element ensuring request.

The BFR m3, since the data from the MN m1 (the non-real-time application) contains the address CoA but does not contain the control signal (the communication element ensuring request such as the period, etc.), stores this piece of data on the common buffer (S215).

The RMA m2, if it proves by referring to the self-retained resource management table that there is a space area in the communication resources, reads the storage data from the common buffer and transmits the readout data to the destination network.

(Period Look-In Enable Request Process)

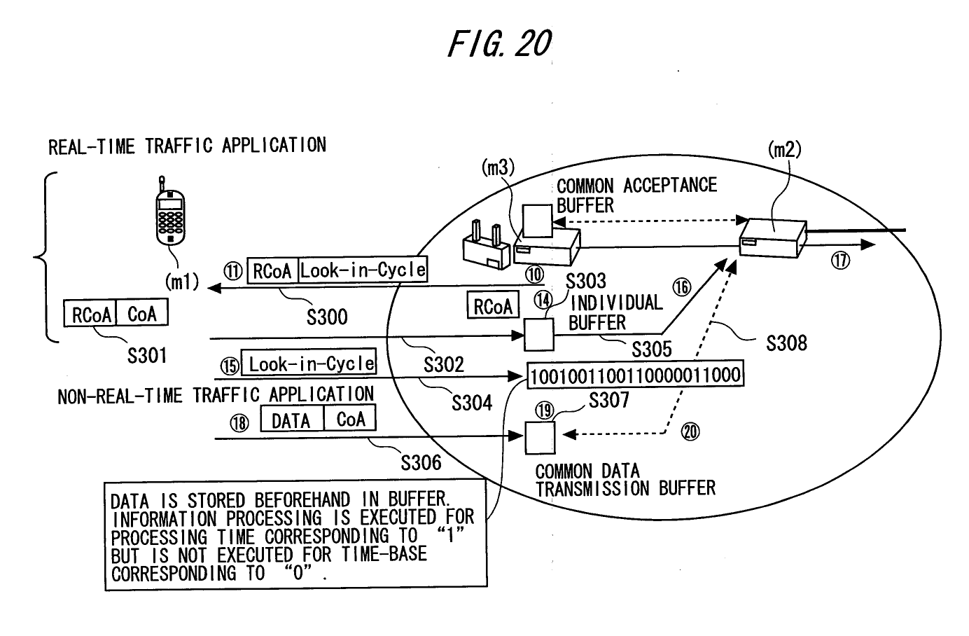

Next, a period Look-in enable request process will be described with reference to FIG. 20. This process is a process executed after S200 through S207 in FIG. 19 and is a process from S300 onward in FIG. 20.

The RMA m2 sends back the RCoA and simultaneously transmits Look-in-Cycle information defined as control information with respect to the transmission data from the side of the MN m1 (S300). For instance, the MN m2 creates the Look-in-Cycle information by setting “1” in a data-transmissible resource location and “0” in locations other than this location in a way that refers to the resource management table (refer to a bit string shown in FIG. 20).

The MN m1, after receiving the RCoA from the RMA m2, registers this RCoA in its own application management table (S301). With this scheme, the address relationship with the real-time application used in the communication element ensuring request is changed from CoA to RCoA.

Namely, hereafter, the real-time application transmits the data to the RMA m2 by use of RCoA (S302).

The RMA m2 temporarily stores (buffers), as the data from the MN m1 (the real-time application) contains the address RCoA, this data in the individual buffer individually generated for RCoA (S303). FIG. 13 shows a storage example of the individual buffer. The data from the MN m1 are retained as in the case of m1 transmission messages 1 through n (data from m1).

The MN m1 requests the BFR m3 for the timing for transmitting the data by sending the Look-in-Cycle information to the BFR m3 (S304). The BFR m3 reads the storage data from the individual buffer at the timing in the Look-in-Cycle information and sends the data to the RMA m2 (S305). The RMA m2 transmits the data from the BFR m3 to the destination network (S306).

Next, the processing of the non-real-time application will be explained.

The non-real-time application transmits the data to the RMA m2 by using not RCoA but CoA (S306). This is a communication process that does not employ the communication element ensuring request.

The RMA m2, since the data from the MN m1 (the non-real-time application) contains the address CoA but does not contain the control signal (the communication element ensuring request such as the period, etc.), stores this piece of data on the common buffer (S307).

The RMA m2, if it proves by referring to the self-retained resource management table that there is a space area in the communication resources, reads the storage data from the common buffer and transmits the readout data to the destination network (S308).

Note that the processes in S300 through S305 and the processes in S306 through S308 can be, it is considered, executed simultaneously.

In this example, the data have already been transmitted, and the pattern for transporting the stored information is transmitted, thereby effecting the transmission based on this pattern.

Further, the buffering filter-function-implemented router m3 (or AP) capable of buffering is disposed anterior to the RMA m2, thereby retaining the information for a fixed period of time. With this router employed, when a sequence number is assigned to the RTT information, if the radio waves are unstable enough to reach with difficulty, pieces of storage information can be organized (arranged) more surely by transmitting the RTT information a plural number of times.

(Period Look-in Enable Reservation Process)

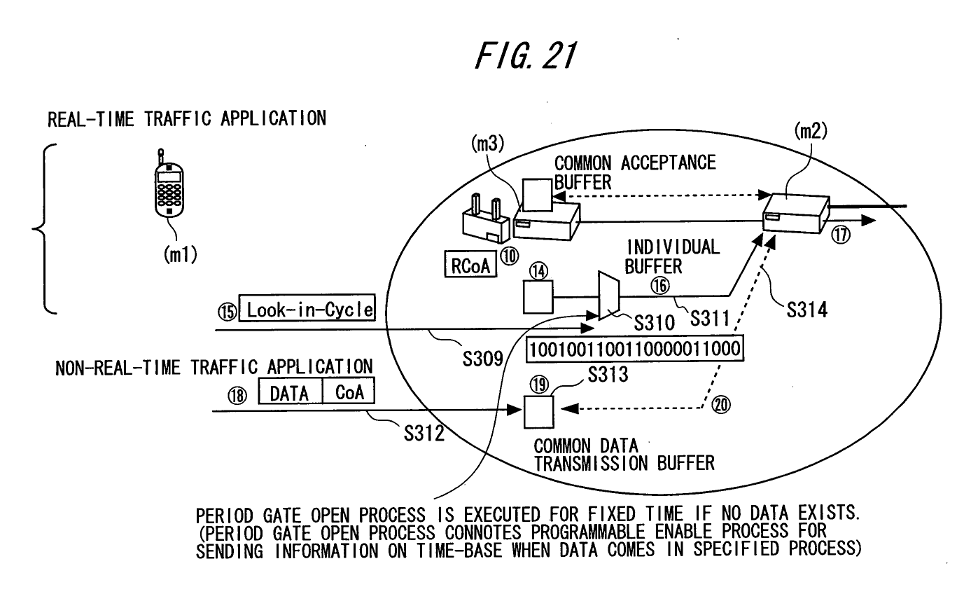

Next, a period Look-in enable reservation process will be described referring to FIG. 21. This process is a process executed after S200 through S207 in FIG. 19 and S300 through S303 in FIG. 20, and is a process from S309 onward in FIG. 21.

The MN m1 transmits the Look-in-Cycle information (S309), however, the BFR m3 performs an operation of retaining the cycle information for a fixed period of time and periodically opening the gate (S310).

As shown in FIG. 21, a different point from in FIG. 20 is that the process in S310 is executed earlier and thereafter the process in S303 can be executed.

The processes in S311 through S314 are the same as the processes in S305 through S308 in FIG. 20, and hence their explanations are omitted.

In this example, the gate is periodically started up, and the data coincident with the target time are flowed into the network by transmitting the data with that period. Further, there can be carried out a method of effecting, with the data arrival serving as a trigger, the timing transmission with this pattern.

(Details of Operation)

(Communication Element Ensuring Request in MN m1)

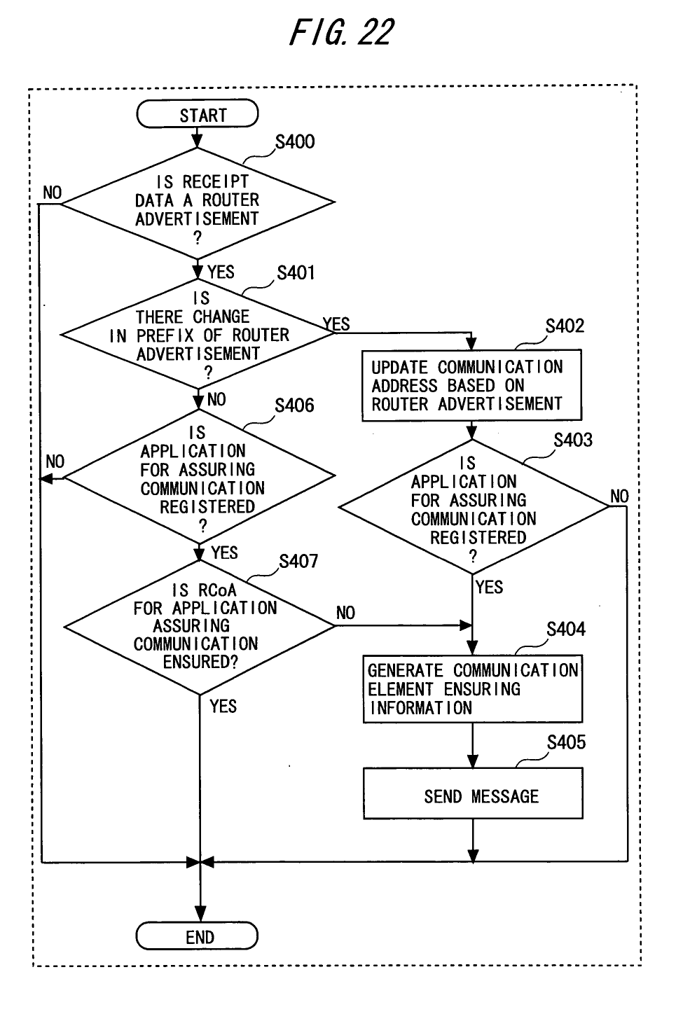

The communication element ensuring request in the MN m1 will be explained referring to FIG. 22.

The MN m1, if the received data is a router advertisement (S400: Yes) and there is a change in the prefix of the router advertisement (S401: Yes), updates the communication address based on this router advertisement (creates the care-of-address CoA) (S402). This is a known mobile IP function.

Then, the MN m1, if it proves by referring to the its own application management table shown in FIG. 8 that the application for assuring the communication is registered therein (S403: Yes), generates the communication element ensuring request information (a characteristic requirement of the real-time application) (S404). The MN m1 transmits the communication element ensuring request to the RMA m2 by use of the CoA generated in S402 a short while ago (S405).

Whereas if there is no change in the prefix of the router advertisement (S401: No) while the application for assuring the communication is registered (S406: Yes), and if the RCoA is not ensured for the application for assuring the communication (S407: No), in the same way as described above, the communication element ensuring request information is generated (S404) and is transmitted as a message to the RMA m2 (S405).

As explained above, the MN m1, when the application for assuring the communication is registered, makes the communication element ensuring request.

(Process for Communication Element Ensuring Request in RMA m2)

The RMA m2, as the communication element ensuring request (request condition) from the MN m1 contains the address CoA and also the control signal (the period, etc.), stores this communication element ensuring request on the common control buffer (S103). This operation has already been explained (see FIG. 10).

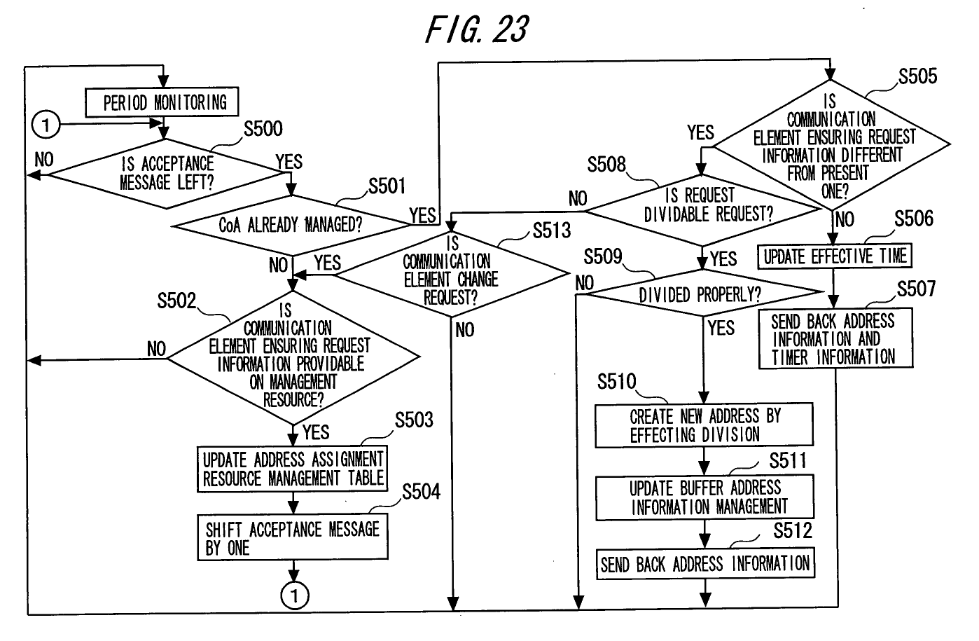

A processing sequence in FIG. 23 is executed each time (periodic) reading timing given by the timer of the RMA m2 is reached.

The RMA m2, when the timer gives the reading timing, reads the communication element ensuring request from the common control buffer if stored with this communication element ensuring request (described as an intermediate acceptance message in FIG. 23) (S500: Yes). If the CoA associated with the readout communication element ensuring request is not coincident with the already-managed CoA (S501: No), the RMA m2 judges whether or not the communication element ensuring request can be provided on the management resources (S502). To be specific, the RMA m2 refers to the self-retained resource management table, then analyzes the acceptance pattern based on the self-allocated resources, and thus judges whether acceptable or not. Then, the RMA m2, if judged providable (acceptable) (S502: Yes), updates an address assigning resource management table (S503). Namely, the RMA m2 generates a unique rental care-of-address (RCoA) for processing the pattern on the network side (S105), and registers the thus-generated address RCoA and the communication element ensuring request (together with, if the effective time is set, this effective time. See FIG. 16) received a short while ago in the resource management table shown in FIG. 13. The RMA m2 shifts the acceptance message by one and again repeats the processes from S500 onward.

While on the other hand, if the CoA associated with the communication element ensuring request read out in S500 is coincident with the already-managed CoA (S501: Yes), the RMA m2 judges whether or not the communication element ensuring request information has a difference from present one (S505). Then, the RMA M2, if not different (S505: No), updates the effective time (S506), and sends the address information and the timer information (S507). This operation has already been explained (see FIG. 8).

Whereas if judged different (S505: Yes), the RMA m2 further judges whether the communication element ensuring request is a dividable request or not (S508). Then, the RMA m2, if judged to be the dividable request (S508: Yes) and if the division can be properly conducted (S509: Yes), generates a new address by effecting the division (S510) then updates the buffer address information management (S511) and sends back the address information (S512). This operation has already been described (see FIG. 10). Note that the judgment as to whether the division can be properly conducted or not (S509) can be, it is considered, made by, for example, the RMA m2 in a way that refers to its own resource management table.

Whereas if not the dividable request (S508: No), the RMA m2 further judges whether the request is a communication element change request or not (S513). Then, if judged to be the communication element change request (S513: Yes), the RMA m2 executes the processes in S502 through S504.

(Post-Acquisition Process of Address in MN m1)

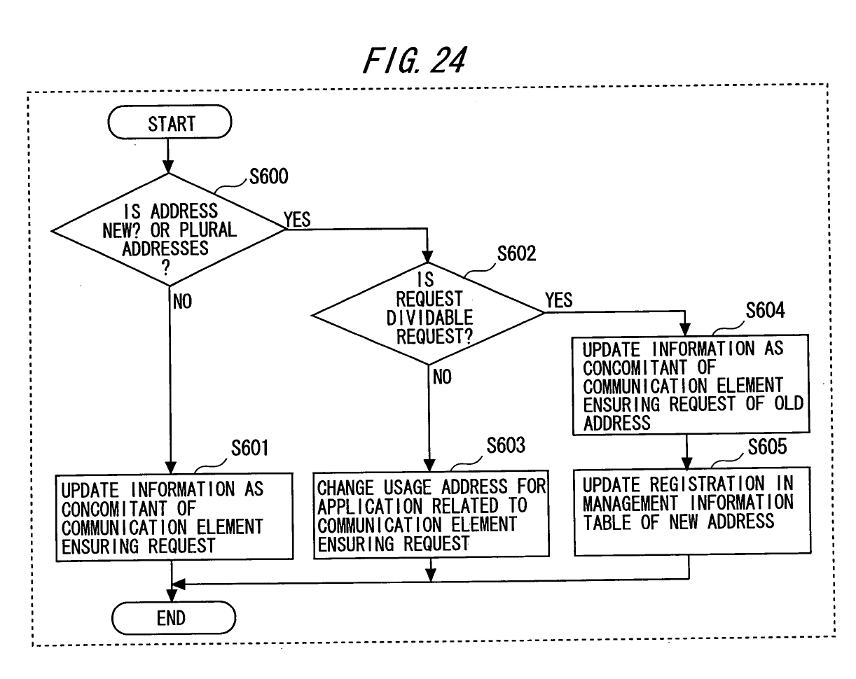

As shown in FIG. 24, the MN m1, if the received address (RCoA) is neither a new address nor plural addresses (S600: No), updates the information as a concomitant of the communication element ensuring request (S601). This operation has already been explained (see FIG. 17).

While on the other hand, if the received address is the new address or the plural addresses (S600: Yes), the MN m1 further judges whether the request is the dividable request or not (S602). Then, if the request is not the dividable request (S602: No), the MN m1 changes a usage address with respect to the application related to the communication element ensuring request (S603). This operation has already been described (see FIG. 10, etc.)

Whereas if the request is the dividable request (S602: Yes), the MN m1 updates the information as the concomitant of the communication element ensuring request about the old address (S604), and updates also the registration in the management information table about the new address (S605) This operation has already been explained (see FIG. 10).

(Reading Process from Individual Buffer in RMA m2)

The RMA m2, as the data from the MN m1 (the real-time application) contains the address RCoA, temporarily stores (buffers) this data in the individual buffer individually generated for the RCoA (S110). This operation has already been described (see FIG. 10).

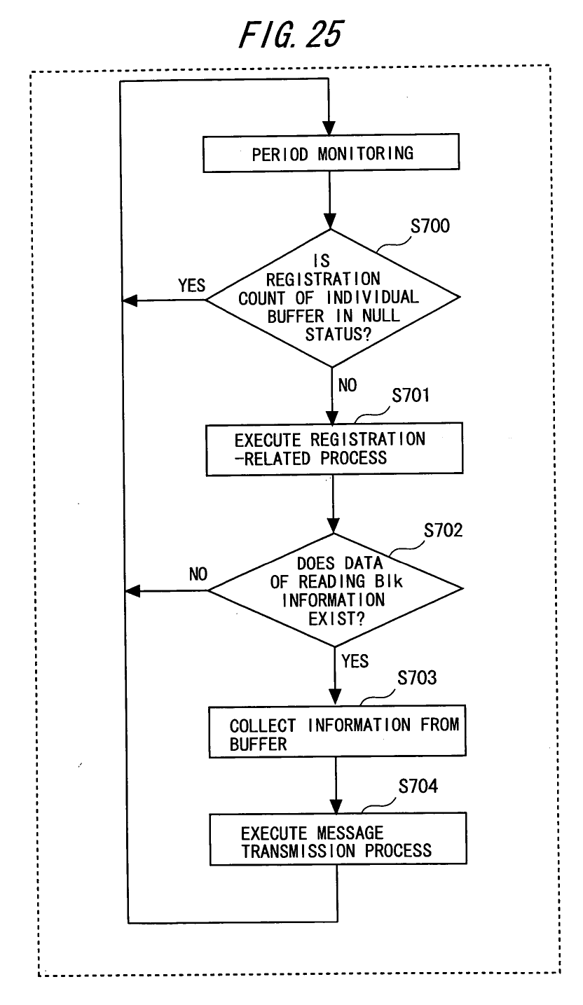

A processing sequence in FIG. 25 is executed each time the (periodic) reading timing given by the timer of the RMA m2 is reached.

The RMA m2, when the timer gives the reading timing, if a registration count in the individual buffer does not show a null status (S700: No), executes a process related to the registration (a process related to the individual buffer information in a block shown in FIG. 14), for instance, a process of monitoring the reference Blk for the registration count by referring to the registration count (S701). Then, if data of Blk information for reading exists (S702: Yes), the RMA m2 collects pieces of information from the buffer (S703), and executes a message transmission process (S704). This operation has already been explained (see FIG. 10).

(Transmittable Period Information Registration Process in RMA m2)

The RMA m2, as the data from the MN m1 (the real-time application) contains the address RCoA, temporarily stores (buffers) this data in the individual buffer individually generated for the RCoA (S110). This operation has already been described (see FIG. 10).

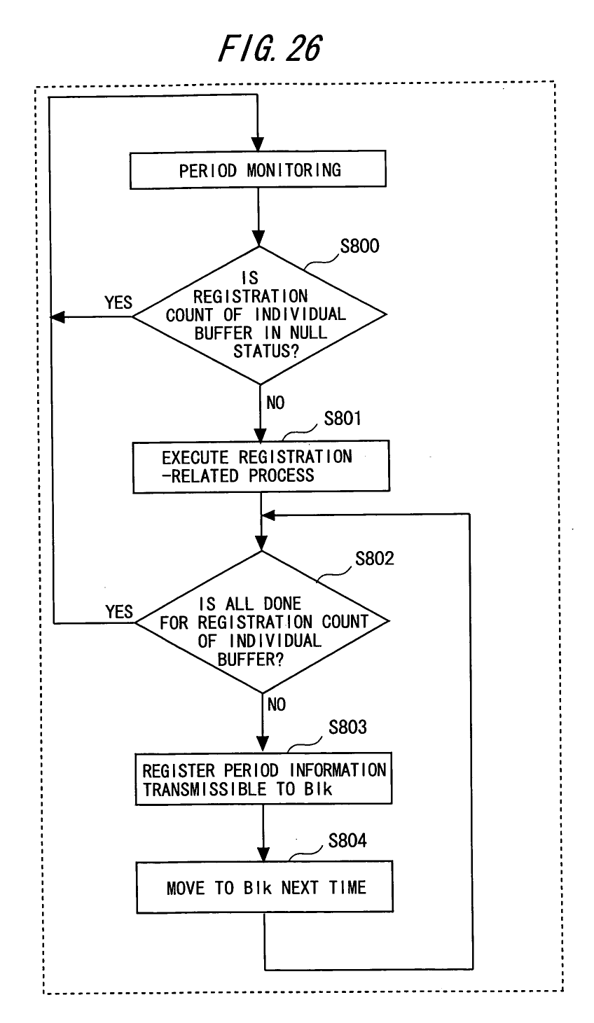

A processing sequence in FIG. 26 is executed each time the (periodic) reading timing given by the timer of the RMA m2 is reached.

The RMA m2, when the timer gives the reading timing, if a registration count in the individual buffer does not show a null status (S800: No), executes a process related to the registration (a process related to the individual buffer information in a block shown in FIG. 14), for example, a process of monitoring the reference Blk for the registration count by referring to the registration count (S801). Then, if not finished all about the registration count in the individual buffer (S802: No), the RMA m2 registers transmittable period information (intermediate assigned pattern information in FIG. 14, which corresponds, i.e., Look-in-Cycle) to the Blk (S803), and moves the information to Blk next time (S804). The process in S802 through S804 is executed for all the registered individual buffers. This operation has already been described (see FIG. 21).

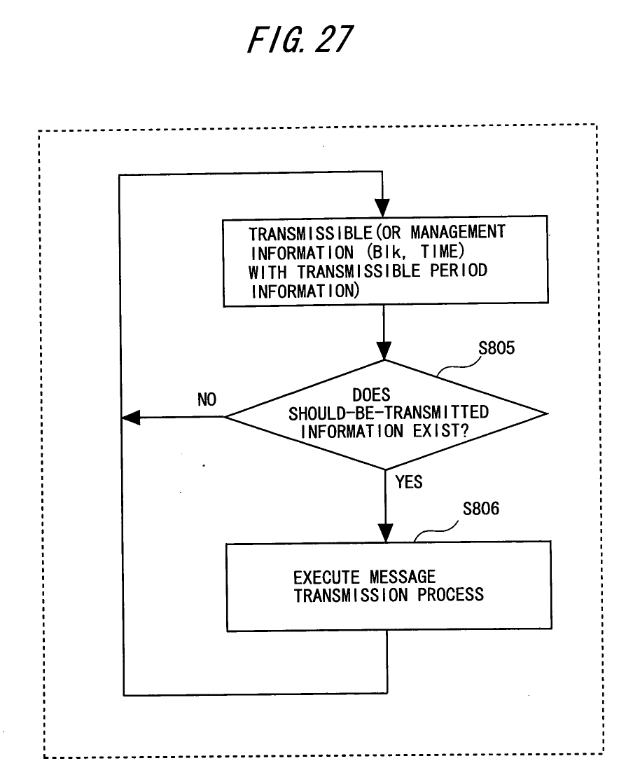

When the transmittable period information is thus registered in every individual buffer, as shown in FIG. 27, the RMA m2, if there exists the information that should be transmitted (S805: Yes), executes the message transmission process (S806).

(Reading Process from Common Buffer in RMA m2)

The RMA m2, since the data from the MN 1 (the non-real-time application) contains the address CoA but does not contain the control signal (the communication element ensuring request such as the period, etc.), stores the data on the common buffer (S114). This operation has already been described (see FIG. 10).

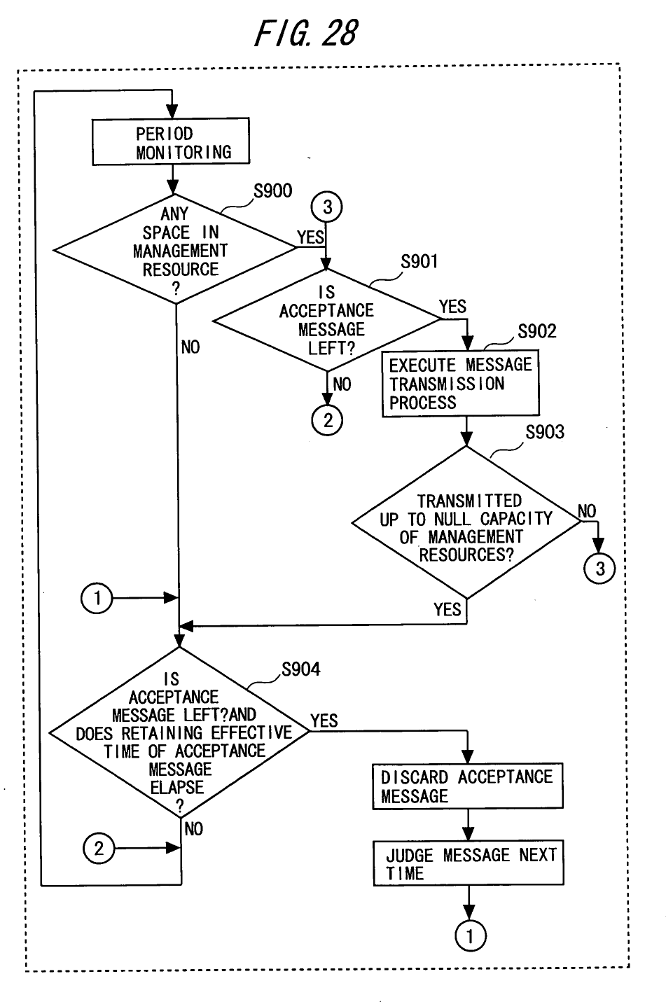

A processing sequence in FIG. 28 is executed each time (periodic) reading timing given by the timer of the RMA m2 is reached.

The RMA m2, when the timer gives the reading timing, if it proves by referring to its own resource management table that there is a space area in the management resources (S900: Yes), further judges whether or not some remaining acceptance messages still exist in the common buffer (S901) Then, if the remaining acceptance messages exist (S901: Yes) the RMA m2 reads the remaining acceptance messages from the common buffer, and executes the message transmission process till the management resources come to a null capacity (S901: Yes, S902, S903: No).

While on the other hand, if no space area exists in the management resources (S901: No), or if transmitted up to the null capacity of the management resources (S903: Yes) the RMA m2 further judges whether or not the acceptance message is left and whether or not the acceptance message is in excess of the retaining effective time (S904). Then, if judged No (S904: No), the RMA m2 returns to S900, and repeats the processes once again. Whereas if judged Yes (S904: Yes), the RMA m2 discards the acceptance message (S905), then makes judgment about the next message (S906), and executes the processes from S904 onward.

The invention can be carried out in a variety of forms without deviating from the spirit or the principal features thereof. Hence, the embodiment is nothing but a simple exemplification in every aspect. The invention should not be limitedly construed by these descriptions.

According to the invention, it is possible to ensure the quality of the specified communication such as RTT, etc. Further, the flexible protocol can be utilized for the core configuration of the network. Still further, the security can be improved and the policies requested can be clearly classified by providing the point capable of controlling by use of only the address desired on the network side. Yet further, the information retained on the routing process side is utilized by way of the open gate, thereby enabling the transmission side to conduct the conscious time management. Moreover, it is feasible to restrain the invalid request from being transmitted in futility across the wireless area. Furthermore, the network linking method and the load-sharing management are facilitated. Still furthermore, when the communication involves using the present system, the information that should be assured just anterior to the communication partner terminal can be provided, and hence the present system becomes superior to other systems in terms.

What is claimed is:

1. A communication method by which a first device and a second device, each having a wireless interface perform communications, comprising:
at the first device, transmitting a communication element ensuring request containing a predetermined communication pattern;
at the second device, judging from a relationship with a self-allocated resource quantity whether a communication having the predetermined communication pattern contained in the communication element ensuring request is acceptable or not, if judged acceptable, generating and transmitting a new address, and retaining an associated relationship between the new address and the predetermined communication pattern;
at the first device, transmitting predetermined information by use of the new address; and
at the second device, transferring the predetermined information transmitted by use of the new address, with the predetermined communication pattern associated with the new address.

2. A communication method according to claim 1, further comprising storing the predetermined information transmitted by use of the new address in a memory, wherein the second device reads the predetermined information from the memory and transfers the predetermined information in accordance with the predetermined communication pattern associated with the new address.

3. A communication method according to claim 1, wherein a single or a plurality of different devices are assigned at least one of a data retaining function, a data collecting function based on the communication element ensuring request and a function of transmitting the information to a network among functions implemented on the second device.

4. A communication method according to claim 1, further comprising transmitting a transmission permissible period information for accepting the first device, at the second device, wherein the first device transmits the transmission permissible period information, and the second device transfers the retained information in accordance with the transmission permissible period information.

5. A communication method according to claim 1, wherein the first device is a mobile communication device, and the second device is a wireless base station.

6. A communication method according to claim 1, wherein the first device is a mobile communication device, and the second device is a mobile support device.

7. A communication method according to claim 1, wherein the wireless interface possessed by the first device is a normal interface.

8. A communication device comprising:
a creating unit creating a communication element ensuring request;
an associating unit associating with an application for making the communication element ensuring request;
a transmitting unit transmitting the communication element ensuring request; and
performing unit performing the communication by use of the new address with respect to the application that has done the associating, when receiving a new address from a device which received the communication element ensuring request.

9. A communication device according to claim 8, further comprising a performing unit performing the communication without using the new address with respect to the application making none of the communication element ensuring request.

10. A communication device making a communication element ensuring request for a plurality of devices in a network in which there exist the plurality of devices each implementing a function possessed by a communication partner device.

11. A communication device according to claim 10, wherein the communication element ensuring request is further made for the communication partner device belonging to the neighborhood of a communication destination terminal.

12. A communication device according to claim 8, wherein the transmitting unit further transmits a new communication element ensuring request, thereby changing allocation of resources with respect to a new piece of address information.

13. A communication device according to claim 8, wherein the transmitting unit further transmits a new communication element ensuring request, thereby requesting, as additional information, an address created a fresh by dividing allocation information in the address information.

14. A communication control device comprising:
a receiving unit receiving a communication element ensuring request containing a predetermined communication pattern from a first device;
a creating unit creating a new address associated with the predetermined communication pattern; and
a transmitting unit transmitting the new address information to the first device.

15. A communication control device according to claim 14, wherein the creating unit generates a random address.

16. A communication control device according to claim 14, wherein a restriction of a predetermined period of time is set in the new address.

17. A communication control device according to claim 14, further comprising a retaining unit retaining, for a fixed period of time, predetermined information transmitted by using the new address from the first device, and a collecting unit collecting and transferring the predetermined information on the basis of a predetermined communication pattern from the retaining unit.

18. A communication control device according to claim 17, wherein when the first device transmits the new address, period indicating information used by the second device to effect the collection is given to the first device.

19. A communication system in which a first device and a second device each having a wireless interface perform communications, comprising:
a first device transmitting a communication element ensuring request containing a predetermined communication pattern;
a second device judging from a relationship with a self-allocated resource quantity whether a communication having the predetermined communication pattern contained in the communication element ensuring request is acceptable or not, if judged acceptable, generating a new address, and retaining an associated relationship between the new address and the predetermined communication pattern; and
a transmitting unit transmitting the new address from the second device to the first device,
wherein the first device transmits the predetermined information by use of the new address, and the second device transfers the predetermined information transmitted by use of the new address, with the predetermined communication pattern associated with the new address.

20. A communication control device for performing communications with a device for transmitting predetermined information, comprising:
a receiving unit receiving the predetermined information transmitted from the device;
a judging unit judging from a relationship with a self-allocated resource quantity whether a communication having the predetermined communication pattern, is acceptable or not, when receiving the predetermined information containing a predetermined communication pattern;
a generating unit generating a new address, if judged acceptable;
a retaining unit retaining an associated relationship between the new address and the predetermined communication pattern;
a providing unit providing the new address to the device; and
a transferring unit transferring the predetermined information with the predetermined communication pattern associated with the new address, when receiving the predetermined information transmitted by use of the new address.

21. A communication device comprising:
a first transmitting unit transmitting a communication element ensuring request containing a predetermined communication pattern by use of a first address;
a receiving unit receiving a second address transmitted from a device judging from a relationship with a self-allocated resource quantity that a communication having the predetermined communication pattern contained in the communication element ensuring request is acceptable; and
a second transmitting unit transmitting the predetermined information by use of the second address.

22. A program for making a communication control device for performing communications with a device for transmitting predetermined information, function as:
a receiving unit receiving the predetermined information transmitted from the device;
a judging unit judging from a relationship with a self-allocated resource quantity whether a communication having the predetermined communication pattern is acceptable or not, when receiving the predetermined information containing a predetermined communication pattern;
a generating unit generating a new address, if judged acceptable;
a retaining unit retaining an associated relationship between the new address and the predetermined communication pattern;
a providing unit providing the new address to the device; and
a transferring unit transferring the predetermined information with the predetermined communication pattern associated with the new address, when receiving the predetermined information transmitted by use of the new address.

23. A program for making a communication device function as:
a first transmitting unit transmitting a communication element ensuring request containing a predetermined communication pattern by use of a first address;
a receiving unit receiving a second address transmitted from a device judging from a relationship with a self-allocated resource quantity that a communication having the predetermined communication pattern contained in the communication element ensuring request is acceptable; and
a second transmitting unit transmitting the predetermined information by use of the second address.
